(19) United States
(12) Patent Application Publication
(10) Pub. No.: US 2012/0106772 A1
(43) Pub. Date: May 3, 2012

(54) SPEAKER DEVICE

(75) Inventors: Minoru Horigome, Yamagata (JP); Hiroyuki Kobayashi, Yamagata (JP); Satoshi Hachiya, Yamagata (JP); Yasuhisa Abe, Yamagata (JP)

(73) Assignees: TOHOKU PIONEER CORPORATION, Yamagata (JP); PIONEER CORPORATION, Kawasaki-shi, Kanagawa (JP)

(21) Appl. No.: 13/382,319

(22) PCT Filed: Jul. 9, 2009
(86) PCT No.: PCT/JP2009/062482

§ 371 Date: Jan. 5, 2012

(51) Int. Cl. H04R 9/06

(52) U.S. Cl. 381/398

(57) ABSTRACT

A diaphragm, a static part vibratably supporting the diaphragm in the vibration direction, and a driving part provided at the static part and applying vibration to the diaphragm in response to an audio signal are provided, and the driving part includes a magnetic circuit forming a magnetic gap, a voice coil vibrating in a different direction from the vibration direction of said diaphragm in response to an inputted audio signal and a rigid vibration direction converter part direction-converting the vibration of the voice coil and transmitting the vibration to the diaphragm, and the vibration direction converter part is connected to an attaching counterpart including the diaphragm and the voice coil and includes a hinge part in the proximity of the attaching counterpart, and a contact avoiding part avoiding contact with the hinge part is formed on the face side of the attaching counterpart in the proximity of the hinge part.

### FIELD OF THE INVENTION

The present invention relates to a speaker device.

### BACKGROUND OF THE INVENTION

FIG. 1 shows a conventional speaker device. As a general speaker device, a dynamic speaker device as disclosed is known (for example, see patent literature 1). For example, as shown in FIG. 1, the dynamic speaker device described in this publication includes a frame 3J, a cone-shaped diaphragm 21J, an edge 4J which supports the diaphragm 21J to the frame 3J, a voice coil bobbin 610J joined to the inner periphery of the diaphragm 21J, a damper 7J which supports the voice coil bobbin 610J to the frame 3J, a voice coil 611J wound around the voice coil bobbin 610J, a yoke 51J, a magnet 52J, a plate 53J, and a magnetic circuit having a magnetic gap in which the voice coil 611J is arranged. In this speaker device, when an audio signal is inputted to the voice coil 611J, the voice coil bobbin 610J vibrates by the Lorentz force developed in the voice coil 611J in the magnetic gap and the diaphragm 21J is driven by the vibration.
[Patent literature 1] Publication of unexamined patent application H8-149596 (FIG. 1)

### DISCLOSURE OF THE INVENTION

### Problems to be Solved by the Invention

The general dynamic speaker device described above is, for example as shown in FIG. 1, configured such that the voice coil 611J is disposed opposite to the sound emission side of the diaphragm 21J, and the vibration direction of the voice coil 611J and the voice coil bobbin 610J is the same as the vibration direction of the diaphragm 21J. In such a speaker device, a region for vibration of the diaphragm 21J, a region for vibration of the voice coil bobbin 610J, and a region for arranging the magnetic circuit, etc. are formed along the vibration direction (sound emission direction) of the diaphragm 21J. Accordingly, the total height of the speaker device inevitably becomes comparatively large.

Specifically, as shown in FIG. 1, the dimension of the speaker device along the vibration direction of the diaphragm 21J is defined by: (a) the height of the cone-shaped diaphragm 21J along the vibration direction plus the total height of the edge 4J which supports the diaphragm 21J to the frame 3J, (b) the height of the voice coil bobbin from the junction of the diaphragm 21J and the voice coil bobbin 610J to the upper end of the voice coil 611J, (c) the height of the voice coil, (d) the height mainly of the magnet of the magnetic circuit, corresponding to the height from the lower end of the voice coil 611J to the upper end of the yoke 51J, and (e) the thickness mainly of the yoke part 51J of the magnetic circuit, etc. The speaker device as described above requires sufficient heights of the above-mentioned (a), (b), (c), and (d) to ensure a sufficient vibration stroke of the diaphragm 21J. Further, the speaker device requires sufficient heights of the above-mentioned (c), (d), and (e) to obtain a sufficient driving force. Accordingly, particularly in a speaker device for large volume, the total height of the speaker device inevitably becomes large.

Since the vibration direction of the voice coil bobbin 610J is the same direction as the vibration direction of the diaphragm 21J in conventional speaker devices as described above, the total height of the speaker devices inevitably becomes large to ensure the vibration stroke of the voice coil bobbin 610J, when seeking a large volume of sound by increasing the amplitude of the diaphragm 21J. Thus, it becomes difficult to make a device thin. In other words, making a device thin and securing a large volume of sound are contradictory.

Nevertheless, in order to efficiently transmit the vibration of the voice coil 611J to the diaphragm 21J, a direct transmission of the vibration from the voice coil 611J to the diaphragm 21J, i.e. the alignment of the vibration direction of the voice coil 611J and the vibration direction of the diaphragm 21J is preferable. In the case that the vibration direction of the voice coil 611J and the vibration direction of the diaphragm 21J are different, the vibration of the voice coil 611J may not be securely transmitted to the diaphragm 21J, which may cause deterioration of the reproduction efficiency of the speaker device.

On the other hand, in a conventional dynamic type speaker device, since the voice coil bobbin 610J is joined to an inner periphery part of the diaphragm 21J having cone-shape and a driving force is transmitted from the voice coil bobbin 610J to the inner periphery part of the diaphragm 21J, it is comparatively difficult to drive the whole diaphragm substantially in the same phase. Therefore, a speaker device allowing the whole diaphragm to vibrate substantially in the same phase is desired.

It is an object of the present invention to overcome the problem described above. That is, an object of the present invention is to provide a thin speaker device capable of emitting a loud reproduced sound with a comparatively simple configuration, a speaker device with a high reproduction efficiency capable of securely transmitting the vibration of the voice coil to the diaphragm, a thin speaker device capable of emitting a high-quality reproduced sound with a comparatively simple configuration, or a thin speaker device capable of vibrating the diaphragm substantially in the same phase with a comparatively simple configuration.

### Means for Solving the Problem

To achieve the above-mentioned object, the present invention has at least a configuration according to the following independent claim.

### [Claim 1]

A speaker device includes a diaphragm, a static part for vibratably supporting the diaphragm in the vibration direction and a driving part provided at the static part and applying vibration to the diaphragm with an audio signal. The driving part includes a magnetic circuit forming a magnetic gap a voice coil vibrating in a different direction from the vibration direction of the diaphragm in response to an inputted audio signal and a rigid vibration direction converter part direction-converting the vibration of the voice coil and transmitting the vibration to the diaphragm. The vibration direction converter part is connected to an attaching counterpart including the diaphragm and the voice coil and includes a hinge part located in the proximity of the attaching counterpart, and a contact avoiding part avoiding contact with the hinge part is formed on the face side of the attaching counterpart in the proximity of the hinge part.

### BRIEF DESCRIPTION OF THE DRAWINGS

FIG. 1 is a view illustrating a conventional related art;

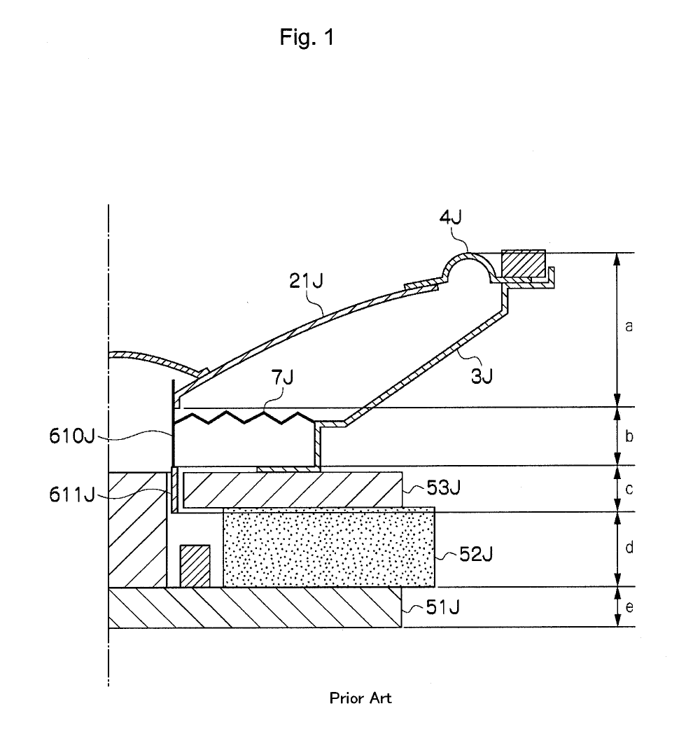

FIG. 2 is a view illustrating the overall configuration of a speaker device according to an embodiment of the present invention (FIG. 2(a) is a cross-sectional view in the X axial direction and FIG. 2(b) is a view illustrating the operation of a driving part);

FIG. 3 is a view illustrating a magnetic circuit and a voice coil of a speaker device according to an embodiment of the present invention;

FIG. 4 is a view illustrating a magnetic circuit and a voice coil of a speaker device according to an embodiment of the present invention;

FIG. 5 is a view illustrating a magnetic circuit and a voice coil of a speaker device according to an embodiment of the present invention;

FIG. 6 is a view illustrating a magnetic circuit and a voice coil of a speaker device according to an embodiment of the present invention;

FIG. 7 is a view illustrating an example of configuration and operation of a vibration direction converter part in a speaker device according to an embodiment of the present invention;

FIG. 8 is a view illustrating an example of configuration and operation of a vibration direction converter part in a speaker device according to an embodiment of the present invention;

FIG. 9 is a view illustrating an example of forming a vibration direction converter part in a speaker device according to an embodiment of the present invention (FIG. 9(a) is a side view, FIG. 9(b) is a perspective view, and FIG. 9(c) is an enlarged view of the part A in FIG. 9(b));

FIG. 10 is a view illustrating another example of forming a vibration direction converter part according to an embodiment of the present invention;

FIG. 11 is a view illustrating an example of forming a hinge part;

FIG. 12 is a view illustrating another example of forming a hinge part;

FIG. 13 is a view illustrating the entire configuration of a speaker device according to another embodiment of the present invention (FIG. 13(a) is a cross-sectional view in the X axial direction and FIG. 13(b) is a view illustrating the operation of a driving part);

FIG. 14 is a view illustrating a speaker device according to another embodiment of the present invention (FIG. 14(a) is a cross-sectional view in the X axial direction and FIG. 14(b) is a view illustrating the operation of a driving part);

FIG. 15 is a view illustrating an example of forming a contact avoiding part used for a speaker device according to an embodiment shown in FIG. 14;

FIG. 16 is a view illustrating an example of forming a contact avoiding part used for a speaker device according to an embodiment shown in FIG. 14;

FIG. 17 is a view illustrating an example of forming a contact avoiding part used for a speaker device according to an embodiment shown in FIG. 14;

FIG. 18 is a view illustrating a vibration direction converter part used for a speaker device according to an embodiment shown in FIG. 14. (FIG. 18(a) is a perspective view, FIG. 18(b) is an enlarged view of the part A in FIG. 18(a));

FIG. 19 is a view illustrating a vibration direction converter part used for a speaker device according to an embodiment shown in FIG. 14. (FIG. 198(a) is a plan view in which the hinge part is extended to planarize the overall part, FIG. 198(b) is a plan view in which the hinge part is extended to planarize the overall part);

FIG. 20 is a view illustrating another example of the vibration direction converter part according to an embodiment of the present invention (FIG. 20(a) is a side view, FIG. 20(b) is a perspective view);

FIG. 21 is a view illustrating another example of the vibration direction converter part according to an embodiment of the present invention (a view illustrating an operation);

FIG. 22 is a view illustrating another example of the vibration direction converter part according to an embodiment of the present invention;

FIG. 23 is a view illustrating another example of the vibration direction converter part according to an embodiment of the present invention;

FIG. 24 is a view illustrating an improvement of an embodiment shown in FIG. 20;

FIG. 25 is a view illustrating a variation of the vibration direction converter part;

FIG. 26 is a view illustrating a speaker device according to another embodiment of the present invention;

FIG. 27 is a view illustrating a variation of the driving part;

FIG. 28 is a view illustrating a variation of the driving part;

FIG. 29 is a view illustrating a variation of the driving part;

FIG. 30 is a view illustrating a variation of the driving part;

FIG. 31 is a view illustrating a speaker device according to an embodiment of the present invention;

FIG. 32 is a view illustrating a speaker device according to another embodiment of the present invention;

FIG. 33 is a view illustrating a speaker device according to another embodiment of the present invention;

FIG. 34 is a view illustrating a speaker device according to another embodiment of the present invention;

FIG. 35 is a view illustrating a speaker device according to another embodiment of the present invention;

FIG. 36 is a view illustrating a speaker device according to another embodiment of the present invention;

FIG. 37 is a view illustrating a speaker device according to another embodiment of the present invention;

FIG. 37 is a view illustrating a speaker device according to another embodiment of the present invention;

FIG. 39 is a view illustrating a speaker device according to another embodiment of the present invention;

FIG. 40 is a view illustrating a speaker device according to another embodiment of the present invention;

FIG. 41 is a view illustrating a speaker device according to another embodiment of the present invention;

FIG. 42 is a view illustrating a speaker device according to another embodiment of the present invention;

FIG. 43 is a view illustrating an example of carrying a speaker device according to an embodiment of the present invention; and

FIG. 44 is a view illustrating an example of carrying a speaker device according to an embodiment of the present invention.

### BEST MODE OF PRACTICING THE INVENTION

Hereinafter, an embodiment of the present invention is described with reference to the drawings. The embodiment of the present invention includes the disclosure of the drawings, but is not limited only to the embodiments described in these drawings. Further, in the following description for each of the drawings, the part having a common description with the previously described part bears the same symbol and the duplicate description is partially saved.

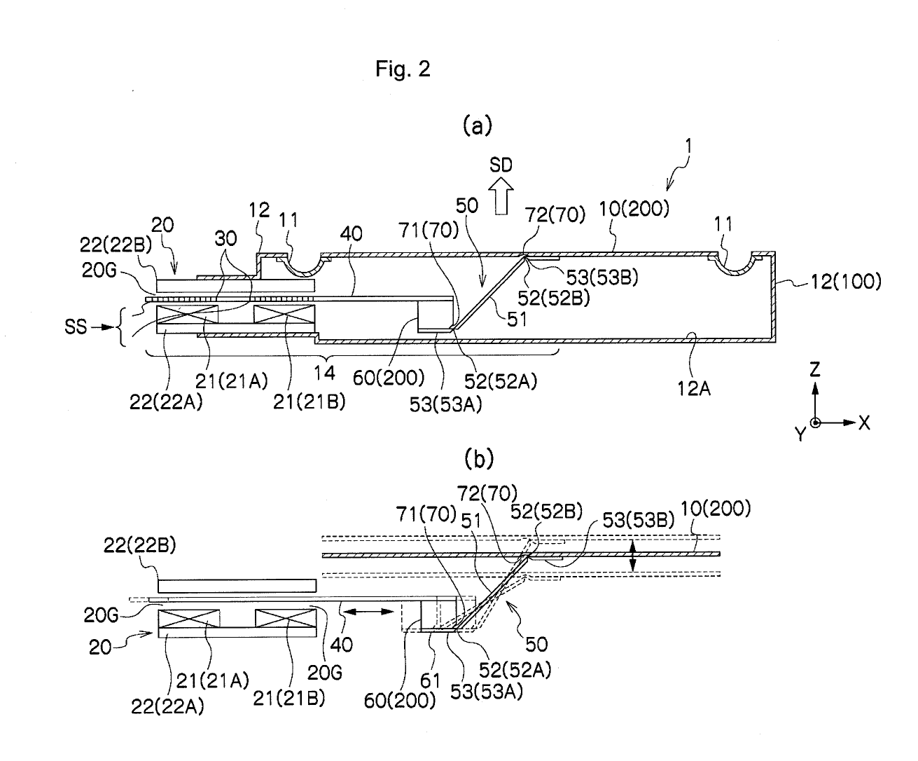

### [Basic Configuration of a Speaker Device: FIG. 2]

FIG. 2 is a view illustrating a basic configuration of a speaker device according to an embodiment of the present invention (FIG. 2(a) is a cross-sectional view in the X axial direction, and FIG. 2(b) is a view illustrating an operation of the driving part). A speaker device 1 is provided with a diaphragm 10, a static part 100 which vibratably supports the diaphragm 10 in the vibration direction and a driving part 14 which is provided on the static part 100 and applies a vibration to the diaphragm 10 in response to an audio signal. The driving part 14 includes a magnetic circuit 20 forming a magnetic gap 20G, a voice coil 30 receiving the audio signal and vibrating in the different direction from the vibration direction of the diaphragm 10, and a vibration direction converter part 50 which direction-converts the direction of the vibration of the voice coil 30 and transmits the vibration to the diaphragm 10. As indicated, although the voice coil 30 is supported by a voice coil support part 40, the voice coil 30 itself may be connected to the vibration direction converter part 50. Here, the vibration direction of the voice coil 30 is defined as X axial direction and two other directions orthogonal to X axial direction are defined as Y axial direction and Z axial direction respectively.

The plan view of the diaphragm 10 may have substantially a rectangular shape, a circular shape, an elliptical shape, or other shapes. Also, the cross-sectional shape of the diaphragm 10 may be formed in a stipulated form, for example, a tabular shape, dome shape, cone shape and so forth. The cross-sectional shape of the diaphragm 10 has a tabular shape in an example indicated in the drawings, it may have a curved shape. Also, the total height of the diaphragm 10 may be made comparatively small as necessary such that the speaker device 1 can be made thin.

The static part 100 is a collective term for the parts which support the vibration of the diaphragm 10, the driving part 14 and so forth. Here, the frame 12, a yoke part which has also a function of the frame 12 as described later, an attachment unit and so forth may be defined as the static part 100. The static part 100 may not be completely static in itself. The whole part of the static part 100 may vibrate affected by the vibration of the driving part 14 or by other forces. The outer periphery part of the diaphragm 10 is supported via an edge 11 by the frame 12 as the static part 100.

The driving part 14 includes a magnetic circuit 20, a voice coil 30, and the vibration direction converter part 50. The voice coil 30 vibrates in one axial direction along a magnetic gap 20G of the magnetic circuit 20, and the vibration direction converter part 50 direction-converts the direction of the vibration and transmits the vibration to the diaphragm 10. In the example shown in the drawings, the voice coil 30 vibrates in the X axial direction, and the diaphragm 10 is arranged vibratably in the Z axial direction orthogonal to the X axial direction. The vibration direction converter part 50 converts the vibration of the voice coil 30 in the X axial direction to its own changing angle slantwise to the X axial direction, and thereby vibrating the diaphragm 10 in the Z axial direction.

The voice coil 30 is formed with a wound conductive wire as a conductive member to which an audio signal is applied. The voice coil 30 itself is vibratably arranged at the static part 100 or it is vibratably arranged at the static part 100 via the voice coil support part 40. The voice coil support part 40, for example, can be formed with a tabular insulating member. The voice coil 30 is supported on the surface or in the voice coil support part 40. The voice coil support part 40, for example, is formed with a tabular insulating member (base), whereby rigidity (including bending rigidity and torsional rigidity) can be added to all over the voice coil 30.

Further, a plurality of conducting layers 32 are formed outside a conducting wire on the tabular insulating member as the voice coil support part 40. The conducting layer 32 is electrically connected to a voice coil lead wire 31 pulled out of the start point and end point of the conducting wire. Also, the conducting layer 32 is electrically connected to the outside via after-mentioned holding part 15, and functions as a junction wire for inputting an external audio signal into the voice coil 30. Also, for example, when a conducting wire, which is unfixedly connected to the voice coil is wound in a speaker device as a junction wire, additional space for winding a tinsel wire is separately required. However, the conducting layer 32 as a junction wire is formed on the surface of the voice coil support part 40 whereby the space for the junction wire is no longer required, and thus the speaker device can be made thin.

Also, the voice coil 30 and the voice coil support part 40 are formed in a tabular shape in the example as indicated, but they are not limited to this example, and may be formed in a tubular shape. Also, when the voice coil 30 or the voice coil support part 40 supporting the voice coil 30 are formed in a tubular shape, a tabular cover part may be attached to the end part on the side of the vibration direction converter part 50 such that the vibration direction converter part can be angle-variably connected.

This voice coil 30 is held at the static part 100 by a holding part (not shown). The holding part vibratably holds the voice coil 30 or the voice coil support part 40 in the vibration direction (for example, X axial direction) with respect to the static part 100, and is configured to restrict the movement in other directions. For example, the holding part can be transformed in the vibration direction of the voice coil 30 (for example, X axial direction) and can be formed by a curved plate member having rigidity in the direction intersecting this vibration direction. Further, the voice coil 30 is configured such that the length of the voice coil in the direction orthogonal to the vibration direction of the voice coil 30 is comparatively larger than the length in the vibration direction of the voice coil 30, whereby a comparatively large driving force can be obtained when driving a speaker.

The vibration direction converter part 50 is provided with a rigid link part 51 and hinge parts 52. The link part is angle-variably and obliquely disposed between the voice coil 30 or the voice coil support part 40 and the diaphragm 10. The hinge parts 52 are formed at both ends of the link part 51 and function as pivot points for angle variation of the vibration direction converter part 50. The end part 53 of the vibration direction converter part 50 is connected to an attaching counterpart 200 including the diaphragm 10 or the voice coil 30, or including a member other than the diaphragm 10 or the voice coil 30 with, for example, a connecting member such as adhesive, a double faced tape, or a fastening member such as a screw member, etc., and a joint part 52 is arranged near the attaching counterpart 200. In the example as indicated, one end part 53 (53A) of the vibration direction converter part 50 is connected to the voice coil 30 or the voice coil support part 40 via a coupling part 60, but it may be directly connected without the coupling part 60. The coupling part 60 is formed between the end part of the vibration direction converter part 50 on the side of the voice coil and the end part of the voice coil 30 or the voice coil support part 40 on the side of the vibration direction converter part, and the coupling part connects both end parts at an interval in the vibration direction. Further, the coupling part 60 includes the thickness of the aftermentioned magnetic circuit such that the speaker device can be made thin.

Further, a contact avoiding part 70, preventing the attaching counterpart 200 from having contact with the hinge part 52, is provided on the face side of the attaching counterpart 200 in the proximity of the hinge part 52 of the vibration direction converter part 50. Also this contact avoiding part 70 functions as a connecting member restraining part for preventing a connecting member interposed between the vibration direction converter part 50 and the attaching counterpart 200 for connecting both members from being involved in the hinge part 52. For example, the contact avoiding part 70 is a recessed part, a notch part, a groove part and so forth formed in a recessed shape along the hinge part 52, forming a predetermined space between the hinge part 52 and the surface of the attaching counterpart 200 arranged in the proximity of near the hinge part 52, thereby preventing the hinge part 52 from having contact with the attaching counterpart 200. In the example shown in the drawings, a notch part 71 is formed as the contact avoiding part 70 at the coupling part 60 as the attaching counterpart 200 so as to be located in the proximity of the hinge part 52 (52A). A recessed part 72 is formed as the contact avoiding part 70 at the diaphragm 10 oppositely in the proximity of the hinge part 52 (52B). Further, the total length of the contact avoiding part 70 of the diaphragm 10 is configured to be substantially the same or larger than the width of the vibration direction converter part 50 along the contact avoiding part 70. As such, the contact between the diaphragm 10 and the hinge part 52 can be suppressed and the occurrence of abnormal noise and so forth caused by the contact can be suppressed. Further, when the end part 53 of the vibration direction converter part 50 and the end face of the coupling part 60 or the diaphragm 10 are joined with a connecting member such as adhesive, a double-face tape and so forth, the adhesive is interposed between the end part of the vibration direction converter part 50 and the end face of the coupling part 60 or the diaphragm 10. The contact avoiding part 70 prevents the adhesive or the end part of the double-face tape running off toward the hinge parts 52 from entering into the notch part 71 or the recessed part 72, thereby preventing them from having contact with and adhering to the hinge part 52.

In the speaker device 1 as described above, when an audio signal SS as an electric signal is inputted into the voice coil 30 of the driving part 14 as shown in FIG. 2(a), the voice coil 30 or the voice coil support part 40 vibrates along the magnetic gap 20G of the magnetic circuit 20, for example, in the X axial direction as shown in FIG. 2(b). As such, the direction of the vibration is direction-converted by the vibration direction converter part 50 and the vibration is transmitted to the diaphragm 10, and thus the diaphragm 10 vibrates for example in the Z axial direction and a sound wave is emitted in the sound emission direction SD corresponding to the audio signal.

According to such speaker device 1, the vibration direction converter part 50 differentiates the vibration direction of the voice coil 30 from the vibration direction of the diaphragm 10, whereby the rear side of the diaphragm 10 can be made thin compared to the case where the voice coil 30 is vibrated in the vibration direction of the diaphragm 10. As such, a thin speaker device, which can reproduce low frequency sound with high sound pressure, can be obtained.

Further, the vibration of the voice coil 30 is direction-converted by the vibration direction converter part 50 and the vibration is transmitted to the diaphragm 10, whereby the thickness of the speaker device 1 in the sound emission direction (the total height of the speaker device) is not increased even when the amplitude of vibration of the diaphragm 10 is increased by increasing the amplitude of vibration of the voice coil 30. As such, a thin speaker device, which can emit a loud reproduced sound, can be obtained.

Further, when the end part 53 of the vibration direction converter part 50 and the attaching counterpart 200 are connected via adhesive as a connecting member, the adhesive spreads and extends on the connecting face along with the connection and runs off toward the hinge part 52, and if the adhesive is applied to the hinge part 52, the hinge part 52 may become hardened and immobilized. Also, when a double face tape is used as a connecting member, if the end part of the double face tape runs off toward the hinge part 52 and the double face tape is applied to the hinge part 52, the hinge part 52 may become hardened and immobilized. Also, the hinge part 52 hardened by the adhesive or the end part of the double face tape applied thereto, may be fractured subjected to repeated bending, folding or rotational movement. If the hinge part 52 is fractured as described above, the portions to which the adhesive, the end part of the double face tape and so forth are applied may repeat contact with and release from the attaching counterpart 200 of the diaphragm 10, the voice coil 30, other members, etc., thereby causing abnormal noise (contact sound) to occur each time. If the applied amount of adhesive or the connecting area by the double face tape is reduced such that the adhesive, the end part of the double face tape and so forth does not run off to be applied to the hinge part 52, a connecting force between the vibration direction converter part 50 and the attaching counterpart 200 is reduced, whereby peel-off, etc. occurs from the end face, causing abnormal noise, or if peeled off completely, causing the breakdown of speaker. Further, since the hinge part 52 is arranged in the proximity of the attaching counterpart 200, the hinge part 52 may have contact with the attaching counterpart 200 causing damage to the hinge part 52 or preventing the vibration direction converter part 50 from bending, folding or rotational movement with respect to the attaching counterpart 200. However, the speaker device 1 according to an embodiment of the present invention has the contact avoiding part 70 formed on the face side of the attaching counterpart 200 which is in the proximity of and opposed to the hinge part 52, whereby the contact between the hinge part 52 and the attaching counterpart 200 is suppressed, and when the end part 53 of the vibration direction converter part 50 and the attaching counterpart 200 are connected by a connecting member such as adhesive or a double face tape and so forth, even if the connecting member runs off along with the connection, the connecting member can be prevented from entering into the contact avoiding part 70, being applied to the hinge part 52, and interrupting the movement of hinge part 52. As such, the function of the hinge part 52 can be maintained while highly keeping the connecting force between the vibration direction converter part 50 and the attaching counterpart 200. Thus, the vibration direction converter part 50 reliably bends, folds or performs a rotational movement with respect to the attaching counterpart 200, whereby fracture can be prevented from causing contact of the hinge part 52 with the attaching counterpart 200, occurrence of abnormal noise and so forth.

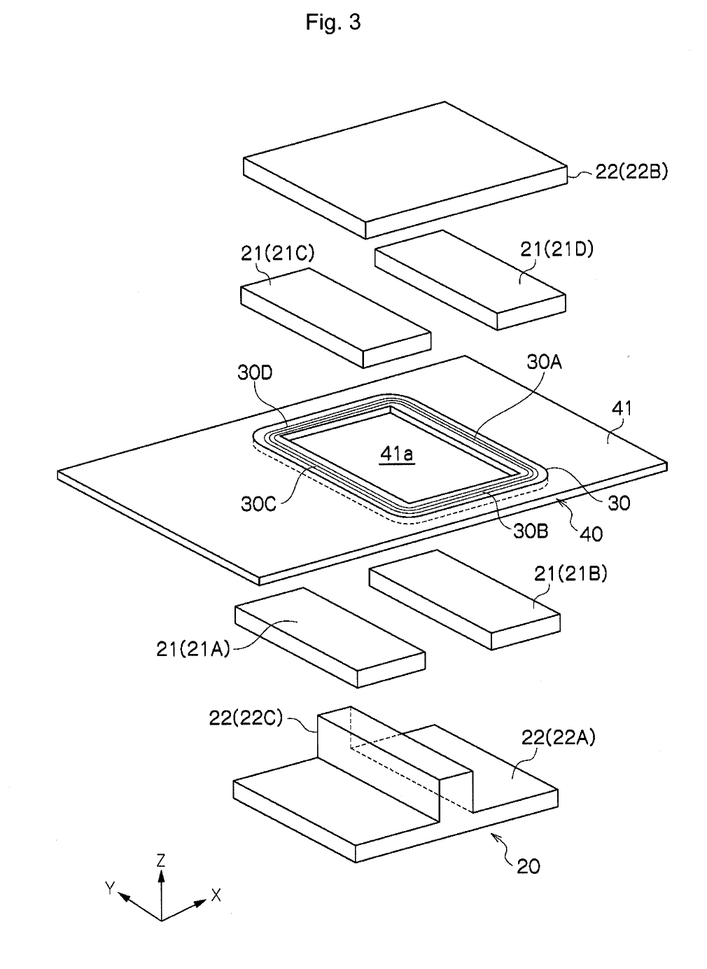

### [Magnetic Circuit/Voice Coil: FIG. 3 to FIG. 6]

FIGS. 3 to 6 are views illustrating a magnetic circuit and a voice coil.

A magnetic circuit 20 for vibrating the voice coil 30 forms a magnetic gaps 20 G in the vibration direction of the voice coil 30, and the magnetic gaps 20G forms a pair of magnetic fields opposite each other in order to apply a Lorentz force (electromagnetic force) to the voice coil 30 by flowing currents (voice currents due to audio signal) through the voice coil 30. As such, when currents flow through the voice coil 30, the voice coil 30 can vibrate in the arrangement direction of the magnetic gap 20G having a pair of magnetic fields.

The magnetic circuit 20 is formed of a magnet 21 and a yoke part 22, and a pair of magnetic gaps 20G having forming magnetic field directions opposite each other in the Z axial direction are formed side by side at a given interval in the X axial direction. And, the conducting wire as a conducting member is wound to form the voice coil 30 such that currents flowing through each magnetic gap 20G are opposite each other in the Y axial direction, and thereby a Lorentz force is applied to the voice coil 30 in the X axial direction. By changing arrangement of the magnet 21 and the yoke part 22, a magnetic circuits 20 having a function similar to what is described above, can be formed.

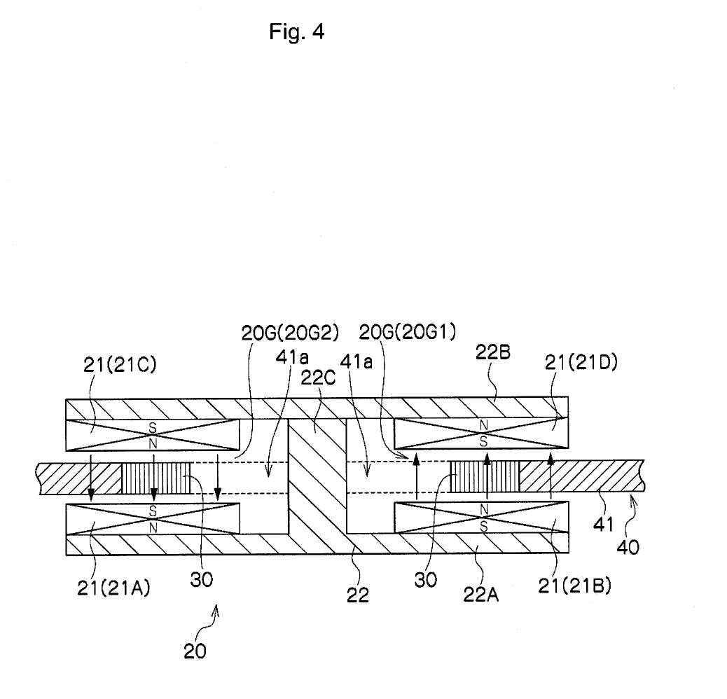

In the example shown in FIGS. 3 and 4, the magnetic circuit 20 includes a plurality of magnets 21 (21A to 21D). In the magnetic circuit 20, the magnets 21 are provided on both sides in the direction of the magnetic field of the magnetic gap 20G. As indicated in the example, the yoke part 22 includes a lower side yoke part 22A, an upper side yoke part 22B and a pole part 22C. The yoke parts 22A and 22B are arranged substantially in parallel at a prescribed interval, and the pole part 22C is formed at central part, so as to extending in the direction substantially orthogonally to the yoke parts 22A, 22B.

The magnets 21A to 21D are arranged at yoke parts 22A, 22B, and one magnetic gap 20G2 is formed with the magnet 21A and the magnet 21C, and another magnetic gap 20G1 is formed with the magnet 21B and the magnet 21D. The pair of, magnetic gap 20G1 and magnetic gap 20G2 is planarly formed side by side such that magnetic fields are formed oppositely each other.

The voice coil 30 has a plane shape formed substantially in a rectangular shape, and is configured provided with straight line parts 30A, 30C formed in the Y axial direction and straight line parts 30B, 30D formed in the X axial direction. The straight line parts 30A, 30C of the voice coil 30 are arranged in each magnetic gap 20G of the magnetic circuit 20 and the direction of the magnetic field is prescribed in the Z axial direction. Preferably, a magnetic field is not applied to the straight line parts 30B, 30D of the voice coil 30. Also, even when a magnetic field is applied to the straight line parts 30B and 30D, the Lorentz forces generated in the straight line parts 30B and 30D are configured to cancel each other out. It is possible to make comparatively large a Lorentz force applied to a part of the voice coil 30 arranged in the magnetic gap 20G by increasing the winding number of conducting wire, thereby obtaining a comparatively large driving force when driving a speaker.

In the example shown in the drawings, the voice coil 30 is supported by the voice coil support part 40 formed with an insulating member 41, and an opening part 41a is formed in the insulating member 41. Alternatively, it is possible to form the entire voice coil 30 in a plate shape by applying rigidity to the voice coil 30 with adhesive and so forth. In this case, the portion to which rigidity is applied with adhesive serves as the voice coil support part 40. If the voice coil 30 has rigidity, the voice coil support part 40 may not be used.

In the example of the magnetic circuit 20 shown in FIG. 3, the magnet 21A and the magnet 21C are magnetized substantially in the same direction and the magnet 21B and the magnet 21D are magnetized in the opposite direction to the magnets 21A and 21C with respect to a plurality of magnets 21A to 21D, such that the direction of a magnetic field applied to the straight line part 30A of the voice coil 30 is opposite to the direction of a magnetic field applied to the straight line part 30C. Magnetization of the magnet 21 can be performed after the magnet 21 and the yoke part 22 are combined, however in the example shown in FIGS. 3 and 4, the process of magnetization when necessary is required to be implemented two times.

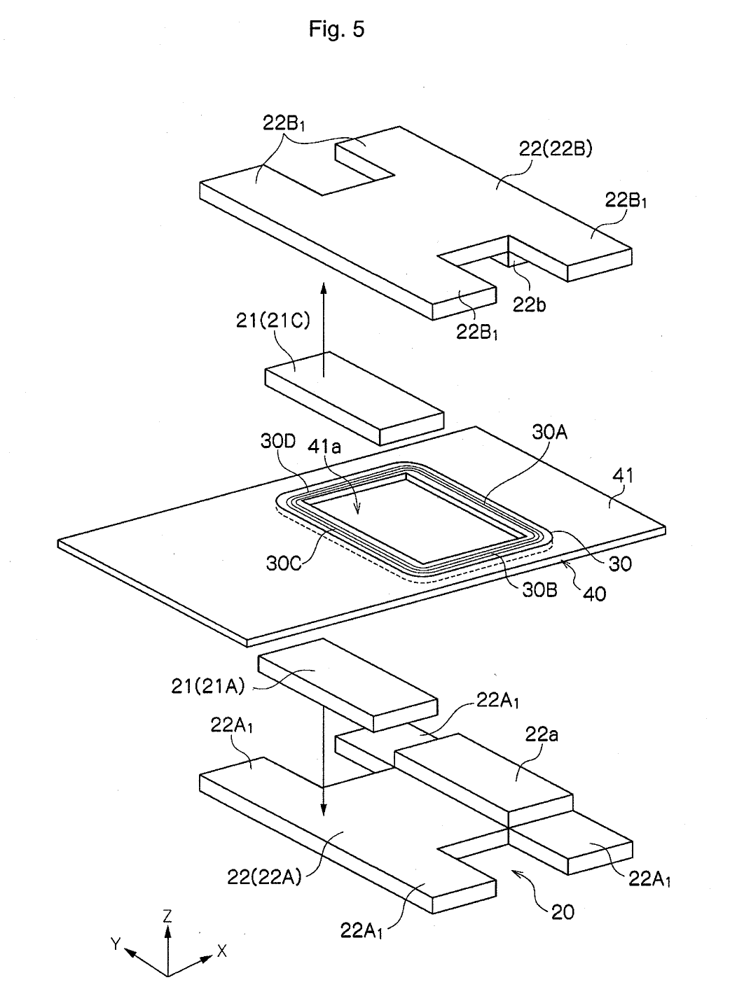

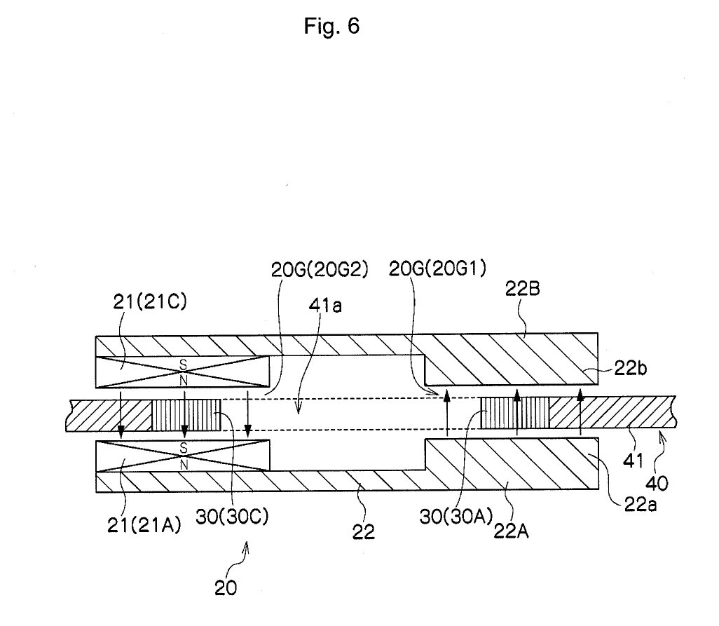

In contrast, in the example shown in FIGS. 5 and 6, the magnetic gap 20G2 is formed with the magnets 21A and 21C that are magnetized substantially in the same direction, and the magnetic gap 20G1 is formed between yoke projecting parts 22a and 22b that are formed at each of the yoke parts 22A and 22B. According to this configuration, magnetization process performed after combining the magnet 21 with the yoke part 22 can be completed one time, thus process can be simplified.

Further, in the example shown in the drawings, positioning supporting parts 22A1, 22B1 are formed at the yoke part 22 itself, which help positioning of the yoke part 22 with respect to the static part such as an attachment part not shown here. According to this configuration, the aforementioned pole part 22C can be eliminated and the interval between the magnetic gaps 20G can be prescribed by positioning of the yoke part 22 with respect to the static part such as an attachment part and so forth.

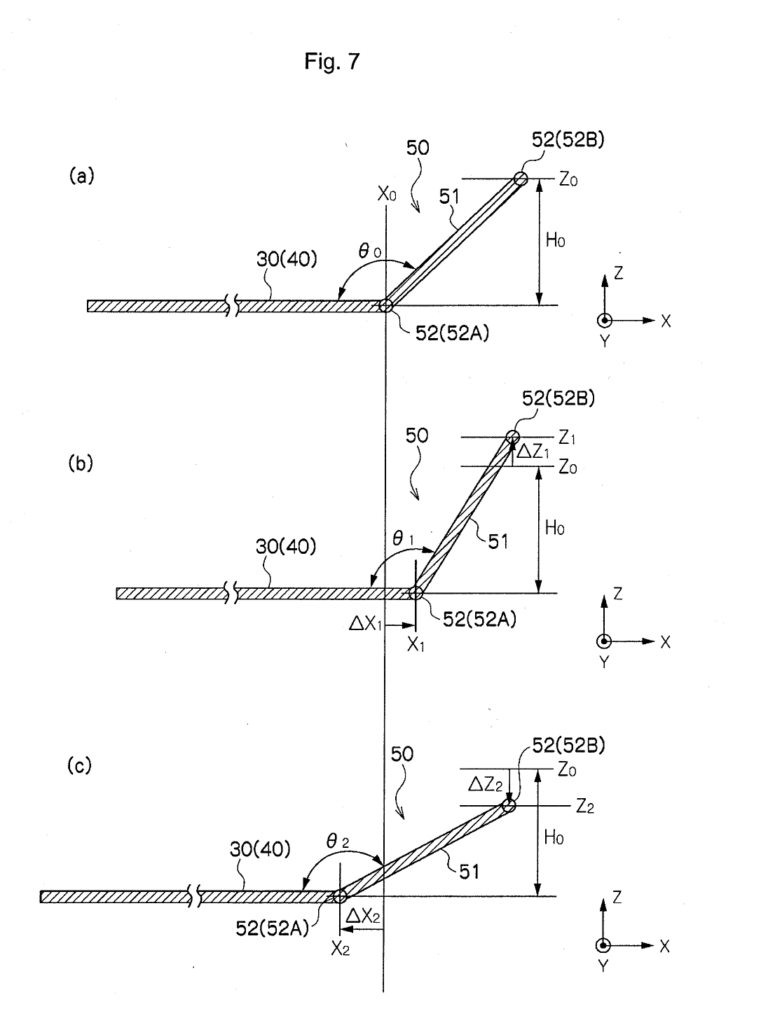

### [Vibration Direction Converter Part: FIG. 7-FIG. 11]

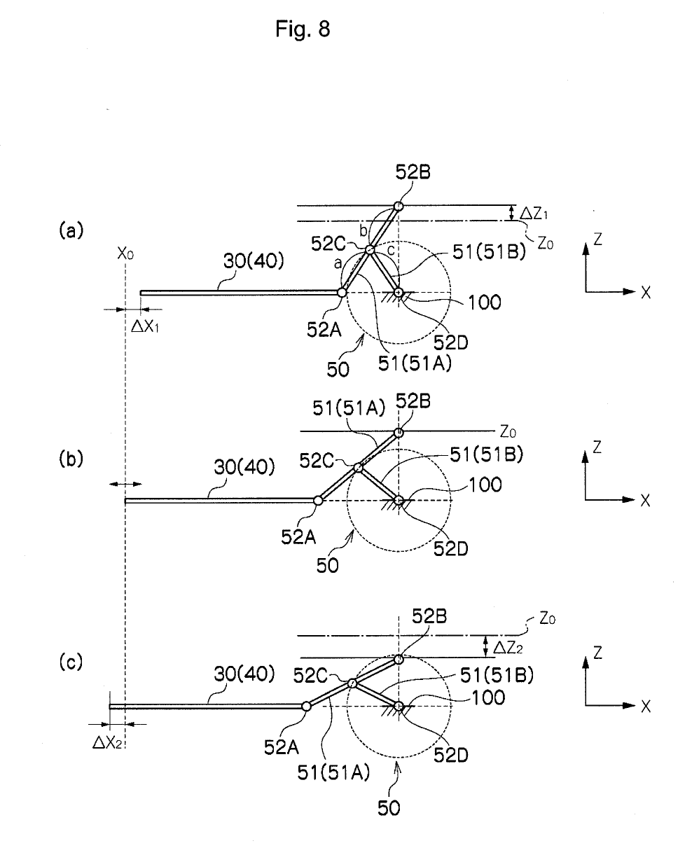

FIGS. 7 and 8 are views illustrating a configuration example and an operation of the vibration direction converter part 50. The rigid vibration direction converter part 50, direction-converting the vibration of the voice coil 30 and transmitting it to the diaphragm 10, has hinges 52 formed on the sides of the diaphragm 10 and the voice coil 30 respectively, and has the link part 51 obliquely disposed with respect to the vibration direction of the voice coil 30. The hinge part 52 is a part that rotatably joins two rigid members or a part that bends or bendably joins integrated two rigid parts, while the link part 51 is a rigid part having the hinge parts 52 formed at the ends. The rigidity means that the members and the parts are not so deformable that the vibration of the voice coil 30 can be transmitted to the diaphragm 10. It does not mean that they are totally undeformable. The link part 51 can be formed in a plate shape or in a rod shape.

In the embodiment shown in FIG. 7, one link part 51 has the hinge parts 52 (52A, 52B) formed at both ends such that the one hinge part 52A is formed at the end of the voice coil 30 or the voice coil support part 40, while another hinge part 52B is formed on the side of the diaphragm 10. Another hinge part 52B may be connected to the diaphragm 10 or connected to the diaphragm 10 via other member. A conventional member may be used as other member. For example, a metal material, etc. improving join strength between the hinge part 52 and the diaphragm 10, may be selected.

FIG. 7(a) shows that the link part 51 is in the middle position of the vibration. The link part 51 is obliquely disposed between the voice coil 30 (or voice coil support part 40) and the diaphragm 10 at an angle θ₀. Meanwhile, the hinge part 52B on the side of the diaphragm 10 is arranged at the position Z₀ apart from the voice coil 30 by distance H₀ in the vibration direction of the diaphragm 10. The vibration direction of the voice coil 30 (or voice coil support part 40) is restricted such that it may vibrate in one axial direction (for example, X axial direction), while the vibration direction of the diaphragm 10 is restricted such that it may vibrate in a direction (for example, Z axial direction) different from the vibration direction of the voice coil 30.

As shown in FIG. 7(b), when the hinge part 52A formed at the end of the voice coil 30 moves from position X₀ to position X₁ by ΔX₁, in the vibration direction (X axial direction), the inclination angle of the link part 51 is converted to be θ₁(θ₀>θ₁) and the position of the hinge part 52B on the side of the diaphragm 10 moves to position Z₁ by ΔZ₁ in the vibration direction of the diaphragm 10 (Z axial direction). More specifically, the diaphragm 10 is pushed up by ΔZ₁ in the vibration direction.

As shown in FIG. 7(c), when the hinge part 52A formed at the end of the voice coil 30 moves from the original position X₀ to the position X2 by ΔX₂ in the vibration direction (-X axial direction), the inclination angle of the link part 51 is converted to be θ₂ (θ₀<θ₂) and the position of the hinge part 52B on the side of diaphragm 10 moves to position Z₂ by ΔZ₂ in the vibration direction of the diaphragm 10 (-Z axial direction). More specifically, the diaphragm 10 is pushed down by ΔZ₂ in the vibration direction.

As such, the vibration direction converter part 50, including the link part 51 and the hinge part 52 (52A, 52B), converts vibration of the voice coil 30 to the change in the angle of the link part 51 obliquely disposed and transmits it to the diaphragm 10, and thus vibrating the diaphragm 10 in a direction different from the vibration direction of the voice coil 30.

FIG. 8 is a view illustrating another configuration example and the operation of the vibration direction converter part 50. Specifically, FIG. 8(b) shows a state of the vibration direction converter part 50 when the diaphragm 10 is positioned in a reference position, FIG. 8(a) shows a state of the vibration direction converter part 50 when the diaphragm 10 is displaced to the sound emission side from the reference position and FIG. 8(c) shows a state of the vibration direction converter part 50 when the diaphragm 10 is displaced in the direction opposite to the sound emission side from the reference position (diaphragm 10 is not shown).

The vibration direction converter part 50 has a function that the link part 51 can angle-convert by receiving reaction force from a static part 100 such as the frame 12 positioned on the opposite side of the diaphragm. Specifically, the vibration direction converter part 50 includes a first link part 51A having one end on the side of the voice coil 30 as a hinge part 52A while another end on the side of the diaphragm 10 as a hinge part 52B and a second link part 51B having one end as a hinge part 52C to the middle part of the first link part 51A while another end as a hinge part 52D to the static part 100, and the first link part 51A and the second link part 51B are obliquely disposed in different directions with respect to the vibration direction of the voice coil 30. More specifically, the vibration direction converter part 50 includes a first link part 51A having one end on the side of the voice coil 30 as a first hinge part 52A while another end on the side of the diaphragm 10 as a second hinge part 52B and a second link part 51B having one end as a third hinge part 52C to the middle part of the first link part 51A while another end as a fourth hinge part 52D to the static part 100, and the first hinge part 52A, the second hinge part 52B and the fourth hinge part 52D are located on the circumference of a circle with a diameter of substantially the same length as the first link part 51A, having the third hinge part 52C as the center.

In the vibration direction converter part 50, the hinge part 52D, supported by the static part 100 (or frame 12), is only the hinge part that does not change position, and thus providing reaction force from the static part 100 for the link part 51. Accordingly, when the voice coil 30 (or the voice coil support part 40) moves from the reference position X₀ by ΔX₁ in the X axial direction, angles of the first link part 51A and the second link part 51B that are obliquely disposed in different directions are increased by substantially the same angle as shown in FIG. 8(a), and thus the hinge part 52B, receiving reaction force from the static part 100 at the hinge part 52D, securely pushes up the diaphragm 10 from the reference position Z₀ by ΔZ₁ in the Z axial direction. Further, when the voice coil 30 moves from the reference position X₀ by ΔX₂ in the direction opposite to the X axial direction, angles of the first link part 51A and the second link part 51B are decreased by substantially the same angle as shown in FIG. 8(c), and thus the hinge part 52B, receiving reaction force from the static part 100 at the hinge part 52D, securely pushes down the diaphragm 10 from the reference position Z₀ by ΔZ₂ in the direction opposite to the Z axial direction.

Length a of a link part from the hinge part 52A to the hinge part 52C, a length b of the link part from the hinge part 52C to the hinge part 52B and the length c of a link part from the hinge part 52C to the hinge part 52D are configured to be substantially the same as each other, and thereby the hinge part 52A and the hinge part 52D are preferably arranged substantially in parallel with the moving direction of the voice coil 30. This link body is well known as a “Scott Russell linkage” where the hinge parts 52A, 52B and 52D are located on the circumference of a circle with the length of the first link part 51A (a+b=2a) as the diameter and the hinge part 52C as the center of the circle. In particular, the angle defined by the line passing through the hinge part 52A and the hinge part 52D and the line passing through the hinge part 52B and the hinge part 52D becomes a right angle. As such, when the voice coil 30 is moved in the X axial direction, the hinge part 52B between the first link part 51A and the diaphragm 10 moves in the Z axial direction that is perpendicular to the X-axis, and thus it is possible to convert the vibration direction of the voice coil 30 to its orthogonal direction and transmit the vibration to the diaphragm 10.

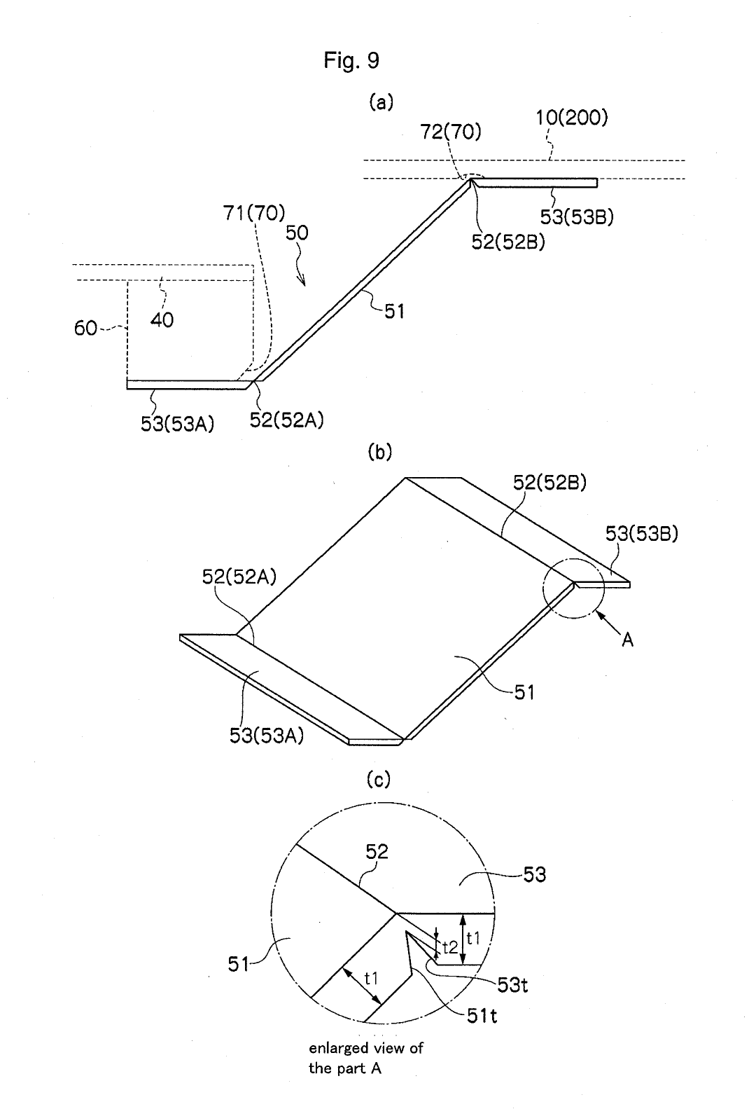

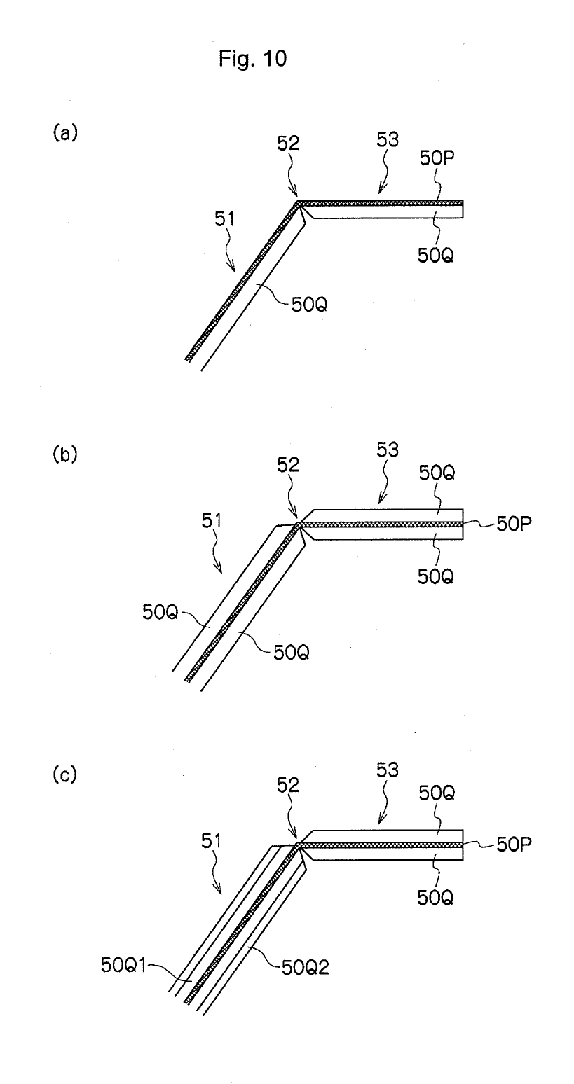

FIGS. 9 and 10 are views illustrating a formation example of the vibration direction converter part 50 (FIG. 9(a) is a side view, FIG. 9(b) is a perspective view and FIG. 9(c) is an enlarged view of part A). The vibration direction converter part 50 includes the link part 51 and the hinge parts (52A, 52B) formed at both ends of the link part 51 as described above. As shown in the drawings, coupling parts 53 (first coupling portion 53A and second coupling part 53B) are formed at both ends of the link part 51 via hinge parts 52. The first coupling portion 53A, connected to the voice coil 30 or the voice coil support part 40 directly or via other member, integrally vibrates with the voice coil 30, while the second coupling part 53B, connected to the diaphragm 10 directly or via other member, integrally vibrates with the diaphragm 10.

In the vibration direction converter part 50, the link part 51, the hinge parts 52A and 52B, the first and second coupling portions 53A and 53B are integrally formed, and the hinge parts 52A and 52B are formed with a bendable continuous member continuing between the parts of both sides over the hinge parts 52A and 52B. This continuous member may be a member configuring the link part 51 and the first and the second coupling portion 53A and 53B as a whole, or may be a member configuring the link part 51 and a part of the first and second coupling portions 53A and 53B. Provided with this second coupling part 53B, the link part 51 may support the diaphragm 10 over a wide range, and thereby it is possible to vibrate the diaphragm 10 in the same phase. The term “fold” includes “bend” in its conceptual scope.

If the vibration direction converter part 50 is formed with a plate shape member, the hinge part 52 is linearly formed extended in a width direction as shown in FIG. 9(b). Further, the link part 51 is required to be rigid and not to be deformable. Since the hinge part 52 is required to be bendable, the integral member is configured to have a different property by forming the thickness t2 of the hinge part 52 smaller than the thickness t1 of the link part 51 or the coupling part 53.

Further, the change in thickness of the hinge part 52 and the link part 51 is formed on a slant face, and the slant faces 51t and 53t, facing the ends of the parts of both sides over the hinge part 52, are formed. As such, when the link part 51 is angle-varied, interference to the angle variation by thickness of the link part 51 may be restrained.

Further, a recessed part or notch part 71, which acts as the contact avoiding part 70, is formed at the end of the coupling part 60 that is an attaching counterpart 200 arranged near the hinge part 52A, such that a space is formed between the hinge part 52A and the coupling part 60 as shown in FIG. 9(a). In an example shown in FIG. 9(a), the notch part is formed in a slantwise cross-sectional shape. Furthermore, the recessed part or notch part 72, which acts as the contact avoiding part 70, is formed at the diaphragm 10 that is an attaching counterpart 200 arranged near the hinge part 52B, such that a space is formed between the hinge part 52B and the diaphragm 10. The total length of the contact avoiding part 70 of the diaphragm 10 is configured to be substantially the same or larger than the width of the vibration direction converter part 50 along the contact avoiding part 70. The total length of the contact avoiding part 70 of the coupling part 60 is configured to be substantially the same or larger than the width of the vibration direction converter part 50 along the contact avoiding part 70. With this configuration, contact between the attaching counterpart 200 and the hinge part 52A can be prohibited. In a case where first coupling portion 53A of the link part 51 and the end face of the coupling part 60 and second coupling part 53B and the diaphragm 10 are joined with adhesive as connecting member, even if the connecting member runs off toward the hinge parts 52A, 52B, the connecting member enters into recessed parts or notch parts 71, 72. Therefore, since the connecting member does not adhere to the hinge parts 52A, 52B, or adheres to only other than hinge parts (part which is rigid and is not bent and folded), bending or folding of the hinge parts 52A, 52B can be prohibited. In other words, as long as the hinge part 52 can be bent and folded substantially, adhesive may be adhered to one part of the hinge part 52. For example, as long as the hinge part 52 can be bent and folded substantially, adhesive may be adhered to one part of the hinge part 52 in the proximity of the coupling part 53. Connecting force between the coupling portions 53 and the diaphragm 10 as an attaching counterpart and the coupling part 60 may be improved by adhering adhesive to one part of the hinge part 52 in the proximity of the coupling part 53 purposely.

In an example shown in FIG. 10, a link part or a coupling part is configured by integrating a bendable continuous member and a rigid member, and a hinge part is a part that is configured by the continuous member. In the example shown in FIG. 10(a), the link part 51 or the coupling part 53 is configured by joining a rigid member 50Q to the surface of a continuous member 50P that is a bendable sheet-shaped member. According to this configuration, the continuous member 50P continuously extends between the parts of both sides over the hinge part 52, and the hinge part 52 is bendably formed substantially only by the continuous member 50P. Meanwhile, the link part 51 or the coupling part 53, which is formed by joining the rigid member 50Q to the continuous member 50P, may be formed as a rigid part.

In an example shown in FIG. 10(b), the rigid members 50Q are applied to sandwich the continuous member 50P to form the link part 51 or the coupling portion 53. Also, the part, not applied with the rigid member 50Q, becomes the hinge part 52. In an example shown in FIG. 10(c), the rigid member forming the link part 51 is formed in multiple layers laminated by the rigid members 50Q1 and 50Q2. Further, in FIG. 10(c), the rigid member 50Q1 and the rigid member 50Q2 may be formed in a multiple-layer structure. As such, the bendable hinge part 52 and the rigid link part 51 and coupling part 53 may be integrally formed by partially joining the rigid member 50Q to the bendable continuous member 50P.

The continuous member 50P is preferably configured to have strength and durability durable against repeated bending of the hinge part 52 when the speaker device is driven, and have flexibility making little noise when bending is repeated. According to one embodiment, the continuous member 50P may be formed with a woven or an unwoven material made of high-strength fiber. As an example of the woven material, plain weave with uniform material, plain weave having different warp and weft material threads, plain weave with alternately changed thread material, plain weave with twisted union yarn and plain weave with paralleled yarn. Other than plain weaves, there may be applied triaxial and quadraxial woven fabrics, triaxial and quadraxial continuous non-woven fabric of glued layer, knitting, fabric with paralleled yarn in one direction, etc.

When the high-strength fiber is applied partially or as a whole, sufficient strength against vibration of the voice coil 30 or the voice coil support part 40 may be achieved by arranging the high-strength fiber in the vibration direction of the voice coil support part 40. When applying both the warp and the weft thread as the high-strength fiber, durability may be improved with a uniform tensile force given to the warp and the weft thread by inclining both fiber directions by 45° with respect to the vibration direction of the voice coil support part 40. As the high-strength fiber, aramid fiber, carbon fiber, glass fiber, etc. may be used. Further, a damping material may be applied to adjust characteristic such as bending stress and rigidity of the continuous member.

As the rigid member 50Q, thermoplastic resin, thermosetting resin, metal, paper, etc., which are light weight, easy to mold and having rigidity after hardening, may preferably be used. The vibration direction converter part 50 may be configured by joining the rigid member 50Q, which is molded in a plate shape, to the surface of the continuous member 50P other than the part of the hinge part 52 by using adhesive as a joining material. Further, if thermosetting resin is used as the rigid member 50Q, the vibration direction converter part 50 may be configured by impregnating partially the link part 51 or the coupling part 53 of the fibrous continuous member 50P with resin and then hardening it. Further, if resin or metal is used as the rigid member 50Q, the continuous member 50P and the rigid member 50Q may be integrated at the link part 51 and the coupling part 53 by using insert molding. The above-mentioned technology concerning the integral forming is described in US20050127233 (Publication No. US2005/253298) filed in the US on May 12, 2005 and US20050128232 (Publication No. US2005/253299) filed in the US on May 13, 2005, which is incorporated here in the present application.

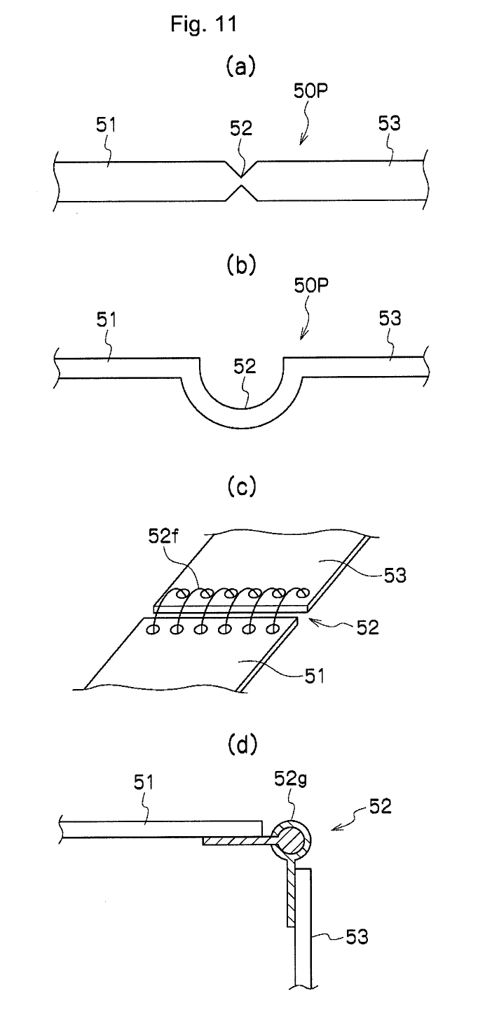

FIG. 11 is a view illustrating a forming example of the hinge part 52. In the example shown in FIG. 11(a), the hinge part 52 is formed by thinning a part of the continuous member 50P. The thick portion of the continuous member 50P is a link part 51 or the coupling part 53, while the thin portion of the continuous member 50P serves as the hinge part 52. In the example as indicated, recessed parts are formed from both faces of the continuous member 50P such that the hinge part 52 is formed. In the example shown in FIG. 11(b), a part of the continuous member 50P is formed in a curved shape such that the hinge part 52 is formed. The straight line part of the continuous member 50P is the link part 51 or the coupling part 53 while the curved part of the continuous member 50P serves as the hinge part 52. FIGS. 11(c) and 11(d) illustrate variations of the present invention. In FIG. 11(c), the hinge part 52 which is formed between the link part 51 and the coupling part 53 or between the link parts 51 is formed by sewing both parts with a linear member 52f. In FIG. 11(d), the hinge part 52 which is formed between the link part 51 and the coupling part 53 or between the link parts 51, is formed with a hinge member 52g.

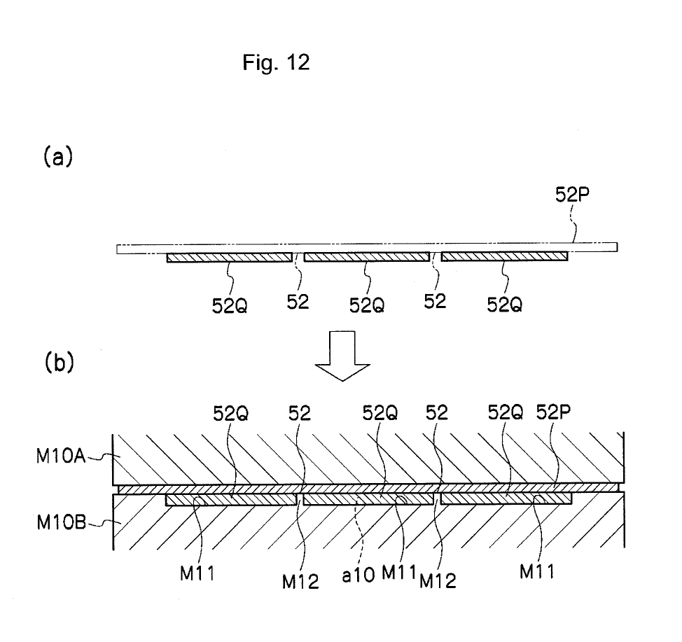

FIG. 12 is a view illustrating another example of forming the hinge part 52. The example shown in FIG. 12(a) illustrates a plurality of rigid members 52Q which are preliminarily formed at intervals in one direction prior to forming the continuous member 52P. In FIG. 12(b), illustrates the rigid members 52Q which are arranged along the tabular mold M10A, and the mold M10B which includes recessed parts M11 and projecting parts M12 which are arranged opposite the rigid members 52Q along the mold M10B are arranged. The projecting parts M12 of the mold M10B are arranged between the rigid members 52Q while the recessed parts M11 of the mold M10B are arranged at the position facing the rigid members 52Q.

After the mold M10A and the mold M10B are arranged as shown in FIG. 12(b), a resin member is injected into the cavity which is formed between the mold M10A and the mold M10B, whereby the continuous member 50P is continuously and integrally formed with respect to the rigid members 52Q. Here, the resin member covers the face of the rigid member 52Q on the side of the continuous member 52P, and the continuous member 52P and the rigid members 52Q are connected. The thickness of the resin member corresponding to the convex part M12 of the mold M10B is formed comparatively small such that the resin member can bend and function as the hinge part 52. Further, the resin member covers the face of the rigid members 52Q, whereby the occurrence of peel-off and so forth can be prevented, thus allowing a speaker device to be used over a long period of time.

Thermosetting resin, thermoplastic resin, foamed resin, soft resin and so forth are listed as the resin member used for this method of forming, and more specifically, rubber, EDM (ethylene-propylene-diene rubber), polyurethane resin, silicon resin, SBR (styrene-butadiene rubber), NBR (nitrile rubber) and so forth are employed. Also, the resin member is preliminarily applied or joined to the face of the mold M10A and the rigid member 52Q, and the continuous member 52P is formed by heating the mold M10B or the continuous member 52P can be also formed by covering the face of the rigid member 52Q with a paper member based on a papermaking method. Also, the mold M10B may be pressed against the mold M10A as necessary. Further, as indicated in the drawings, the continuous member 52P is formed so as to cover one face side of the rigid member 52Q, but not limited to this configuration, and the continuous member 52P may be formed so as to cover both faces of the rigid member 52Q. In this configuration, the mold M10B and another mold which has substantially the same shape as the mold M10B may be arranged so as to sandwich the mold M10A. Further, such that the rigid member 52Q has the additional rigidity, for example, a linear protrusion part or groove part may be provided, or a rod shaped or tabular shaped metal member or a metal member with mesh structure may be arranged inside the rigid member 52Q.

Thermosetting resin, thermoplastic resin, sheet shaped member (prepreg) composed of fabric or unwoven cloth, which is made of carbon fiber, synthetic resin and so forth and impregnated with partially hardened thermosetting resin, and resin film can be listed as the resin members which are used for this method of forming. The rigid member 52Q and the continuous member 52P may be formed concurrently. In this case, so-called two color formation (not shown) is employed. For example, one mold and the other mold provided with the recessed parts and the convex parts are oppositely arranged, and two different resin members are injected into a cavity which is formed between these both molds. Here, the resin member which provides rigidity is injected between one mold and the recessed part of the other mold while the resin member which provides flexibility is injected into between one mold and the projecting part of the other mold. After that, these both molds are heated or in some other way to harden the two resin members, whereby the rigid member 52Q is formed between one mold and the recessed part of the other mold, while the continuous member 52P is formed between one mold and the projecting part of the other mold, and concurrently the hinge part 52 is formed. In this method of forming, for example, thermoplastic resin or thermoplastic elastomer may be used as the resin member for the continuous member 52P, and engineering plastics such as thermoplastic resin including glass fiber (glass fiber reinforced thermoplastic resin) may be listed as the resin member for the rigid member 52Q.

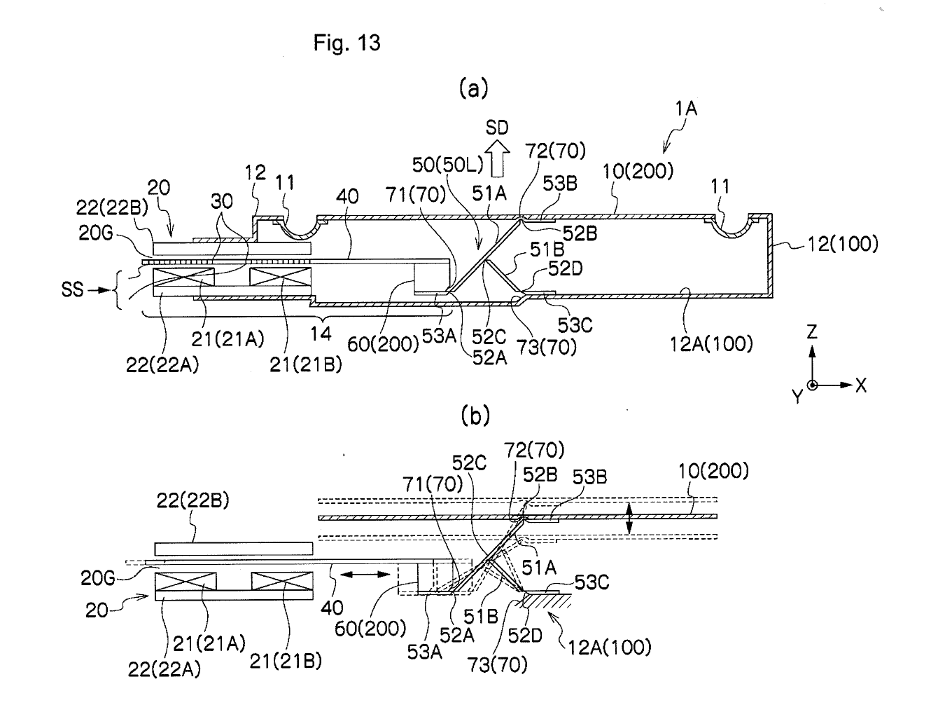

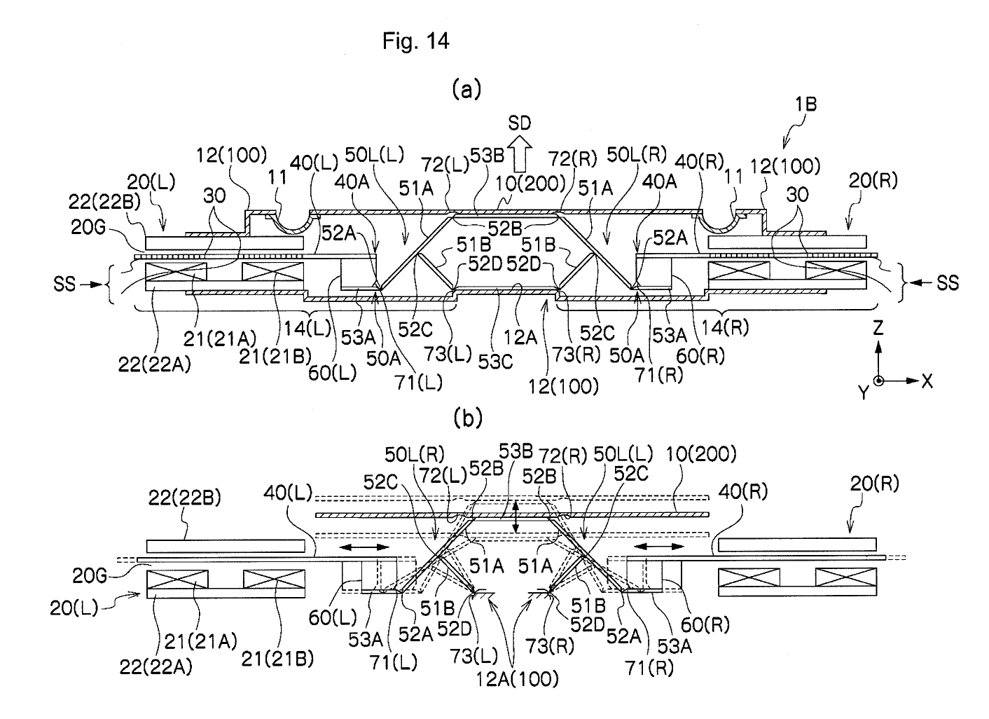

FIGS. 13 to 17 are views illustrating a speaker device according to another embodiment of the present invention (FIG. 13(a) and FIG. 14(a) are a cross-sectional view in the X axial direction and FIGS. 13(b) and 14(b) are views illustrating the operation of a driving part). The part having a common description with the previously described part bears the same symbol and the duplicate description is partially eliminated. In the speaker devices 1A and 1B according to an embodiment shown in FIGS. 13 and 14, a link body 50L includes the first coupling portion 53A which is connected to the voice coil support part 40 and integrally vibrates with the voice coil support part 40, and a second coupling part 53B which is connected to the diaphragm 10 and integrally vibrates with the diaphragm 10, as well as a plurality of link parts.

In the speaker device 1A according to the embodiment shown in FIG. 13, the vibration direction converter part 50 is formed with the link body 50L including the rigid first link part 51A and second link part 51B. The first coupling portion 53A is located at one end of the first link part 51A via the hinge part 52A while the second coupling part 53B is located at another end of the first link part 51A via the hinge part 52B. The middle part of the first link part 51A is located at one end of the second link part 51B via the hinge part 52C while the coupling part 53C, which is static with respect to vibration of the voice coil support part 40, is located at another end of the second link part 51B via the hinge part 52D.

In the example shown in the drawings, the first coupling portion 53A is connected to the end part of the voice coil support part 40 directly or via the coupling part 60, the second coupling member 53B is directly connected to the diaphragm 10, and the stationary coupling part 53C is connected to the bottom part 12A of the frame 12 which serves as the static part 100. In the bottom part 12A of the frame 12 as the attaching counterpart 200 which is arranged in the proximity of and opposite the hinge part 52D, a recessed part or notch part 73 (notch part in the example shown in the drawing) is formed as the contact avoiding part 70, whereby a space is formed between the hinge part 52D and the bottom part 12A of the frame 12. A first link part 51A and a second link part 51B are obliquely arranged in different directions from the vibration direction (X axial direction) of the voice coil support part 40, and the static part 100 is provided on the opposite side of the diaphragm 10 with respect to the vibration direction converter part 50. As indicated in the drawings, the static part 100 is formed with the bottom part 12A of the frame 12. Alternatively, the yoke part 22A of the magnetic circuit 20 may be extended down to the bottom of the vibration direction converter part 50 and the yoke part 22A may be used as the static part 100.

As shown in FIG. 13(b), the hinge part 52A on the side of the voice coil support part 40 moves in the X axial direction in accordance with the movement of the voice coil support part 40 while the hinge part 52D connected to the static part 13 is fixed. The movement of the hinge part 52A is converted to the change in the angles of the first link part 51A and the second link part 51B in response to the reaction force from the static part 13, and thus the hinge part 52B on the side of the diaphragm 10 is moved in the direction of the vibration of the diaphragm 10 (for example, Z axial direction).

The speaker device 1B according to the embodiment shown in FIG. 14 is configured with the driving parts 14 shown in FIG. 13 symmetrically disposed opposite to each other, which includes the driving parts 14(R) and 14(L), respectively. Each of the driving parts 14(R) and 14(L) includes a link body 50L (R) or 50L (L), a voice coil support parts 40(R) or 40(L), a magnetic circuit 20(R) or 20(L) and a coupling part 60(R) or 60(L).

The link bodies 50L(R) and 50L (L) configure the vibration direction converter part 50 such that a pair of the first link parts 51A, a pair of the second link parts 51B, a pair of the first coupling portions 53A, the second coupling part 53B and the static coupling portions 53C, which are disposed opposite to each other, are integrally formed. A pair of the first coupling portions 53A is connected to the voice coil support part 40 respectively, the second coupling part 53B is connected to the diaphragm 10, and the static coupling part 53C is connected to the bottom portion 12A of the frame 12.

As shown in FIG. 14(b), the diaphragm 10 can be driven by two combined driving forces of the driving parts 14(R) and 14(L) by setting the direction of the vibrations of the voice coil support parts 40(R) and 40(L) synchronously opposite to each other. Further, since a plurality of hinge parts 52B are provided on the side of the diaphragm 10, the number of support points on the diaphragm 10 is increased, thereby the phase of vibration of the diaphragm 10 may become uniform.

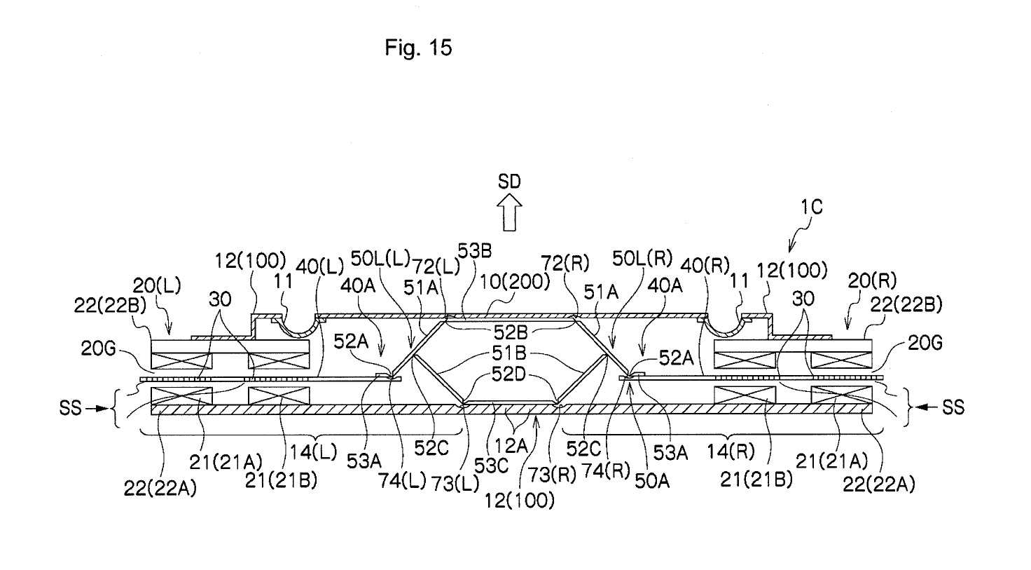

The speaker device 1C, 1D, 1E according to embodiments shown in FIGS. 15 to 17, illustrate an example of forming the contact avoiding part 70 shown in FIG. 14. In the speaker device 1C according to an embodiment shown in FIG. 15, a recessed part or notch part 74 (recessed part is indicated in the example shown in the drawing) is formed as the contact avoiding part 70 respectively at the end part of the voice coil 30 or the voice coil support part 40 as the attaching counterpart 200, which is arranged in the proximity of and opposite the hinge part 52A, whereby a space is formed between the hinge part 52A and the end part of the voice coil 30 or the voice coil support part 40.

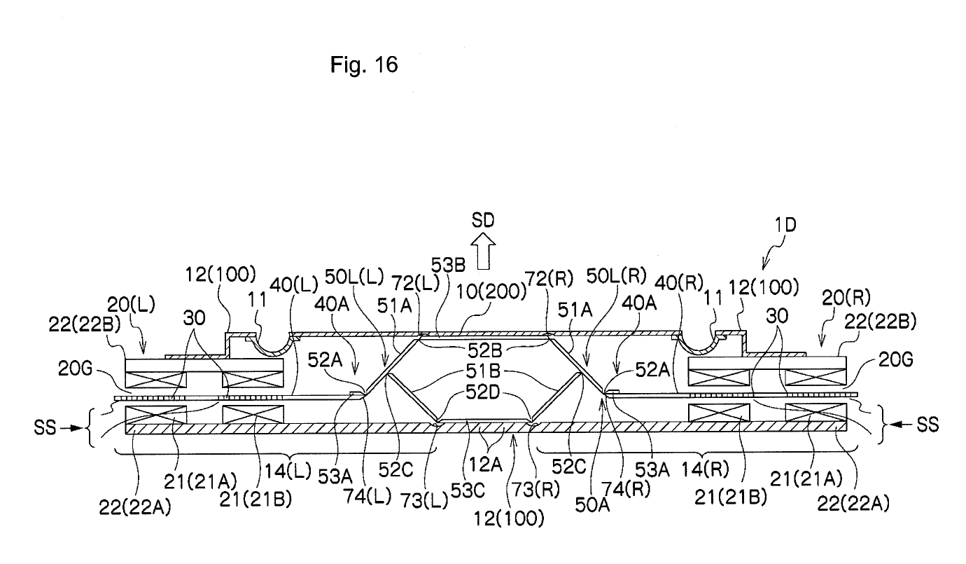

In the speaker device 1D according to an embodiment shown in FIG. 16, a notch part 74 is formed as the contact avoiding part 70 respectively at the end part of the voice coil 30 or the voice coil support part 40 as the attaching counterpart 200, which is arranged in the proximity of near and opposite the hinge part 52A, whereby a space is formed between the hinge part 52A and the end part of the voice coil 30 or the voice coil support part 40.

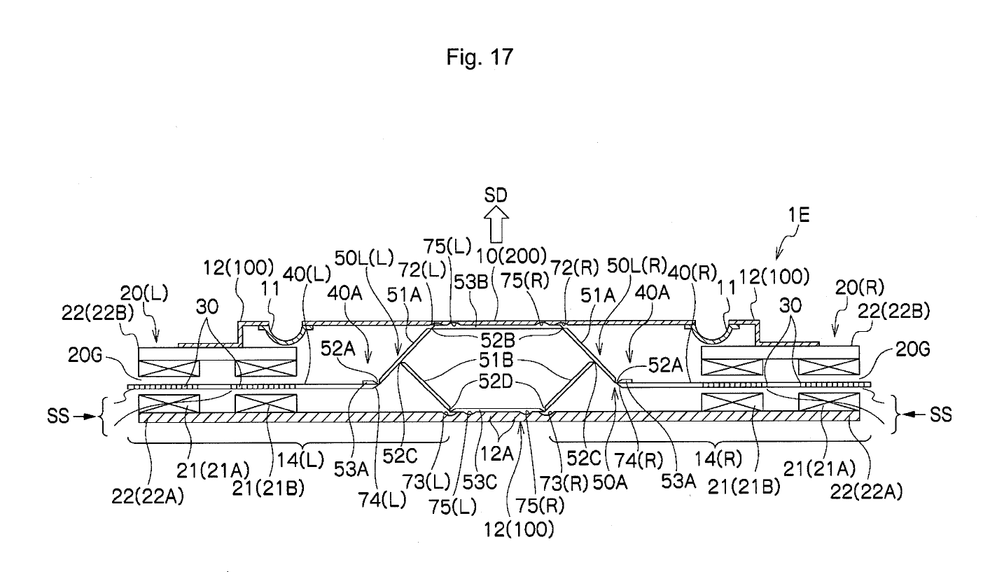

In the speaker device 1E according to an embodiment shown in FIG. 17, a groove part 75 which is filled with adhesive is formed as the contact avoiding part 70 at either side or both sides of the attaching counterpart 200 or the vibration direction converter part 50. The groove part 75 is used as a receiving part for receiving adhesive when the vibration direction converter part 50 and the attaching counterpart 200 are connected by fluid adhesive. Also, the groove part 75 functions as an adhesive restraining part for restraining adhesive. Also, the groove part 75 is arranged nearer to the center side (on the upstream side in the spreading and extending direction of adhesive) than recessed parts or notch parts 71, 72, 73, 74 which are shown as the contact avoiding part 70 in FIGS. 9(a), 13, 14, 15, and 16. Thus, the adhesive spreading and extending along with connection enters into the groove part 75, and the adhesive can be prevented from running off toward the hinge part 52, thereby adhesive can be sufficiently filled to result in a reliable connection. Further, since sufficient adhesive is filled in the groove part 75, the connecting strength between the attaching counterpart 200 and the vibration direction converter part 50 is improved while rigidity of connecting counter part of the vibration direction converter part 50 can be improved. As indicated in the example shown in the drawing, the groove part 75 is arranged nearer to the center side than the recessed parts 72 which are formed in proximity of and opposite the hinge part 52B, respectively at the diaphragm 10 as the attaching counterpart 200, and the groove part 75 is arranged nearer to the center side than the recessed parts 73 which are formed near and opposite the hinge part 52D, respectively at the bottom part 12A of the frame 12. Thus, rigidity of the diaphragm 10 can be increased.

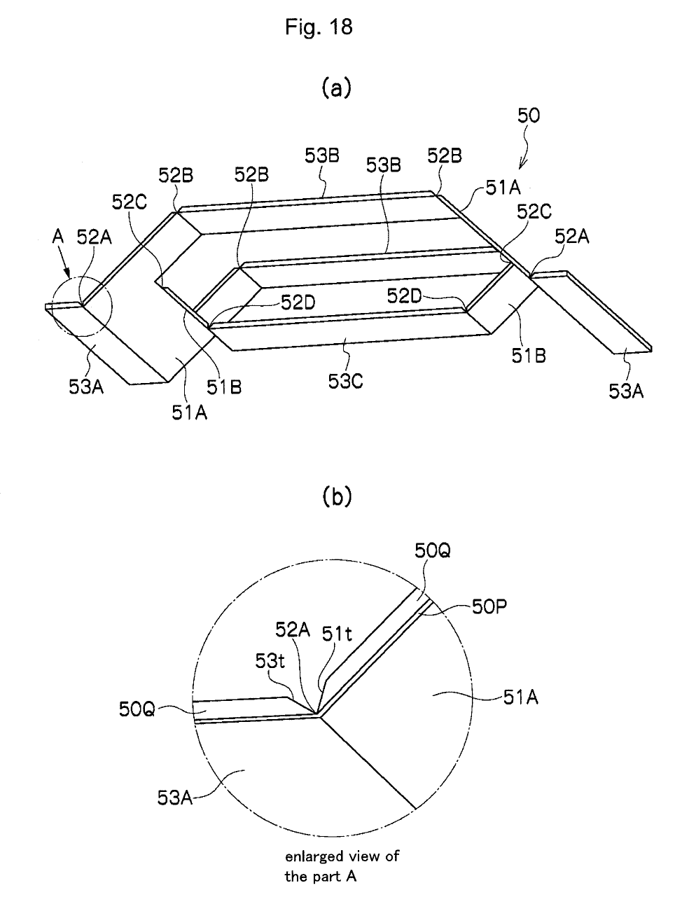

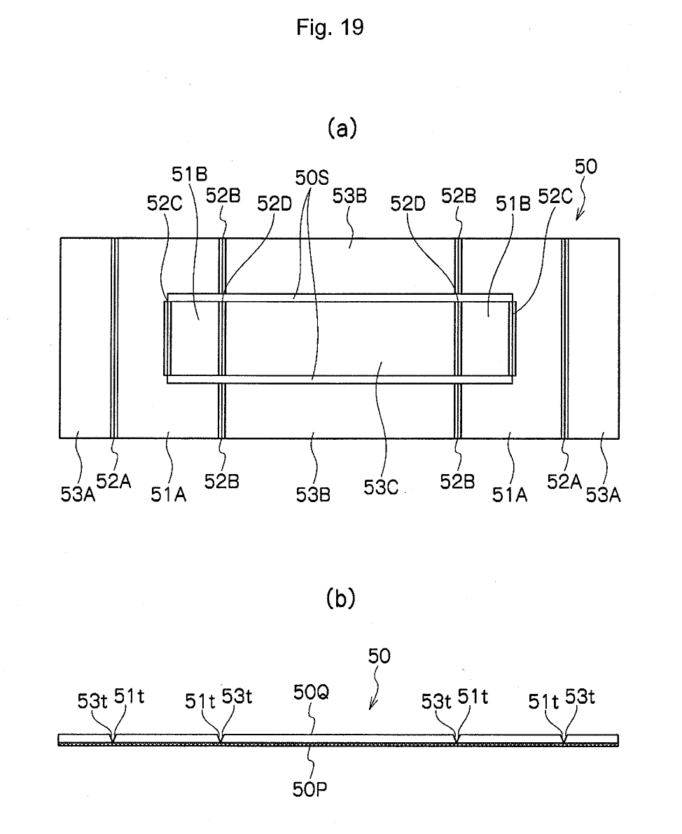

FIG. 18 and FIG. 19 are views illustrating the vibration direction converter parts used in the speaker device 1B-1E according to the embodiment shown in FIGS. 14-17 (FIG. 18(a) is a perspective view, FIG. 18(b) is an enlarged view of the part A in FIG. 18(a), FIG. 19(a) is a plan view illustrating the hinge part the overall part of which is extended and flattened, and FIG. 19(b) is a side view illustrating the hinge part the overall part of which is extended and flattened). The vibration direction converter part 50 is formed with a single integrally formed component, having a pair of first link parts 51A such that hinge parts 52A and 52B are formed at both ends of the first link parts 51A and a pair of second link parts 51B such that hinge parts 52C and 52D are formed at both ends of the second link parts 51B. Further, first coupling portions 53A are formed in the side of one end part of a pair of first link parts 51A via hinge parts 52A, and a second coupling part 53B is formed between hinge parts 52B which are formed in the side of the other end parts of the pair of first link parts 51A, and a static coupling part 53C is formed between hinge parts 52D which are formed in the side of the other end part of second link parts 51B. And, the link part 51A, 51A and the second coupling part 53B are bent in a protruding shape, and the second link parts 51B, 51B and the static coupling part 53C are bent in a recessed shape.

As shown in FIG. 18(b), the hinge part 52A is bendably formed with the above continuous member 50P. The above rigid member 50Q is attached to the first link part 51A and also to the first coupling portion 53A. As such, all of the above-mentioned hinge parts are formed in the similar configuration. Further, slant faces 51t and 53t are formed opposite to each other in each hinge part.

As shown in FIG. 19(a), the vibration direction converter part 50, including the link parts 51A, 51B, each hinge part and the coupling portion 53A, 53B, 53C, is formed with an integral sheet-shaped member. The hinge parts 52A are formed linearly crossing the integral sheet-shaped member, while the hinge parts 52B, 52C, 52D are formed partially crossing the integral sheet-shaped member. A pair of notch parts 50S are formed in a longitudinal direction of the integral sheet-shaped member such that the second link parts 51B, 51B and the static coupling part 53C are cut out and formed.

In order to form such a vibration direction converter part 50, for example, a resin material for forming the rigid member 50Q is applied and stacked over the entire face of the sheet-shaped continuous member 50P, and then the resin material is hardened. After that, a notch part 50S is formed to form each hinge part and slant faces 51t, 53t on both sides of each hinge part by punching out V-shape. Liquid and prehardened resin material or resin film can be employed as the resin member used here.

Further, each hinge part and the slant faces 51t and 53t at both sides of the hinge part may be formed at the same time as forming the rigid member 50Q with the resin material. It is preferable that a cross-sectional V-shape groove or a recessed part is formed preliminarily in a die, which is used to mold the rigid member 50Q.

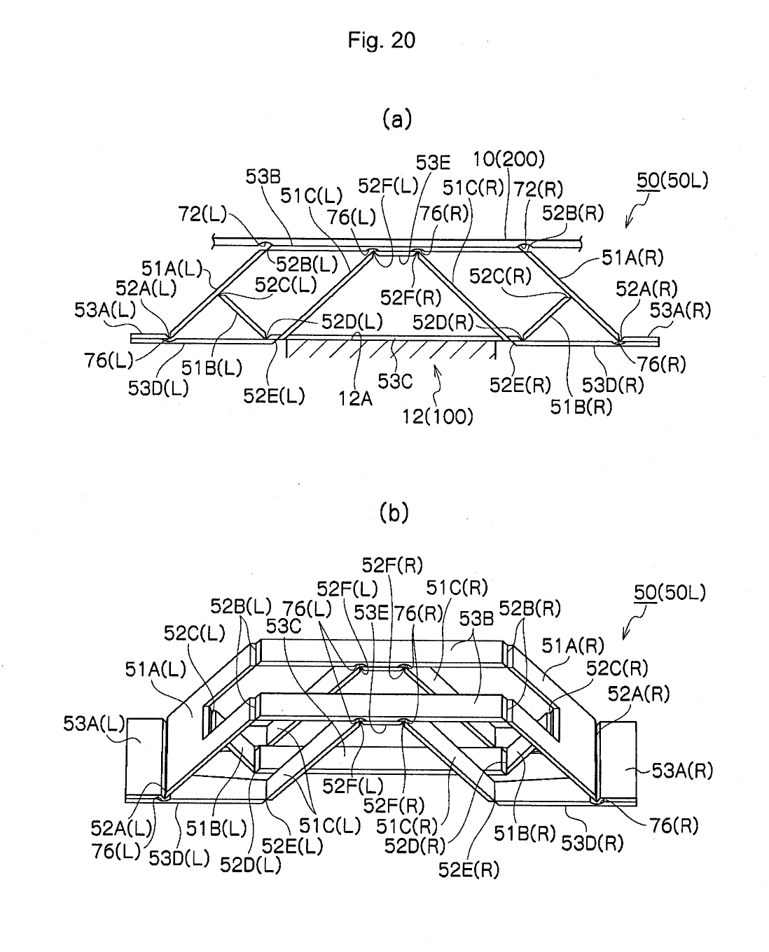

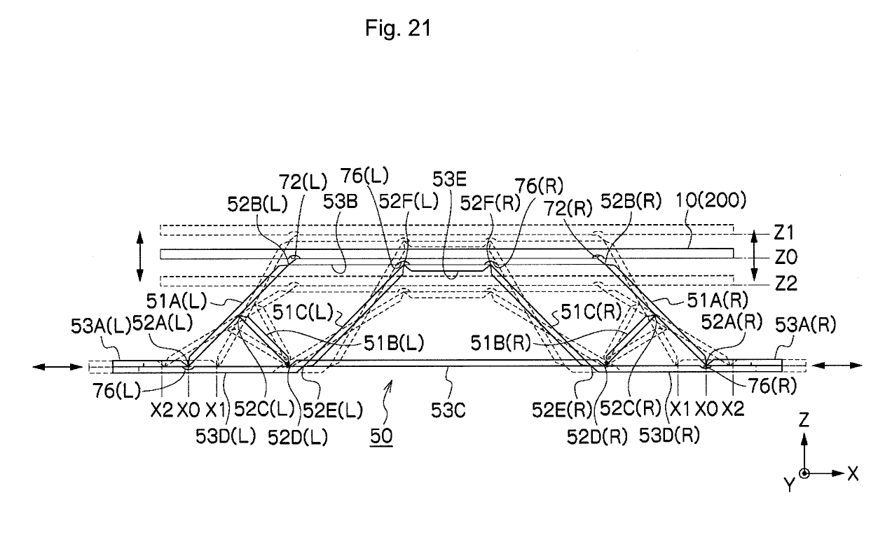

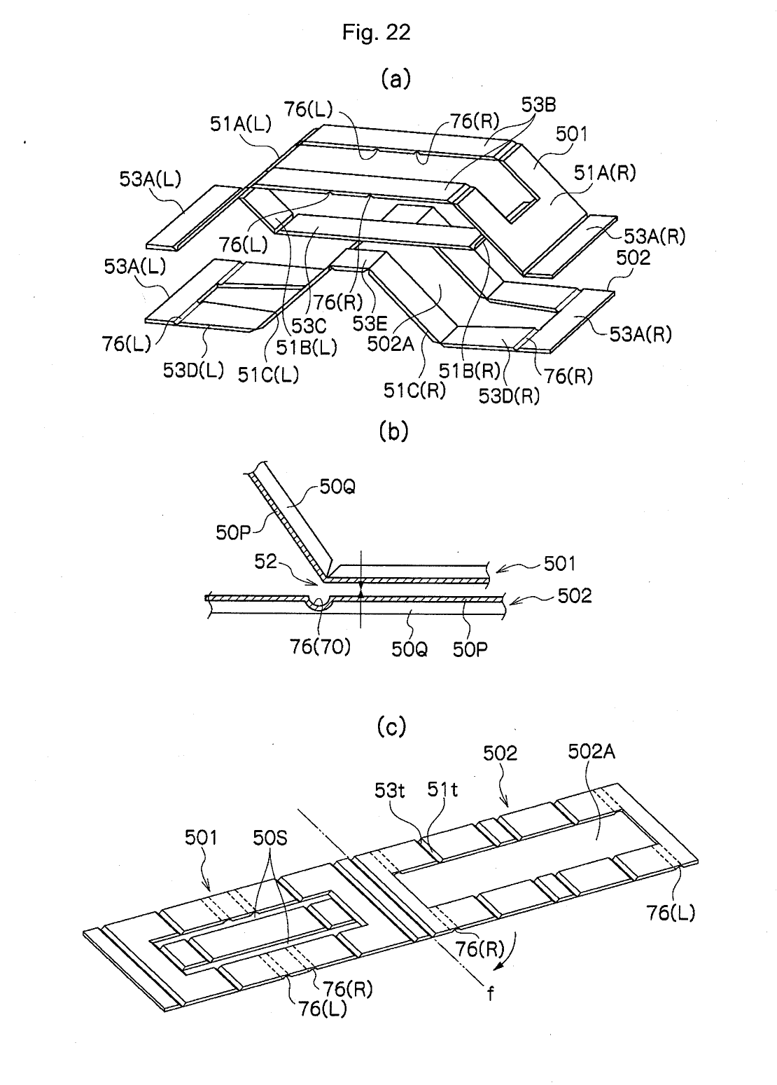

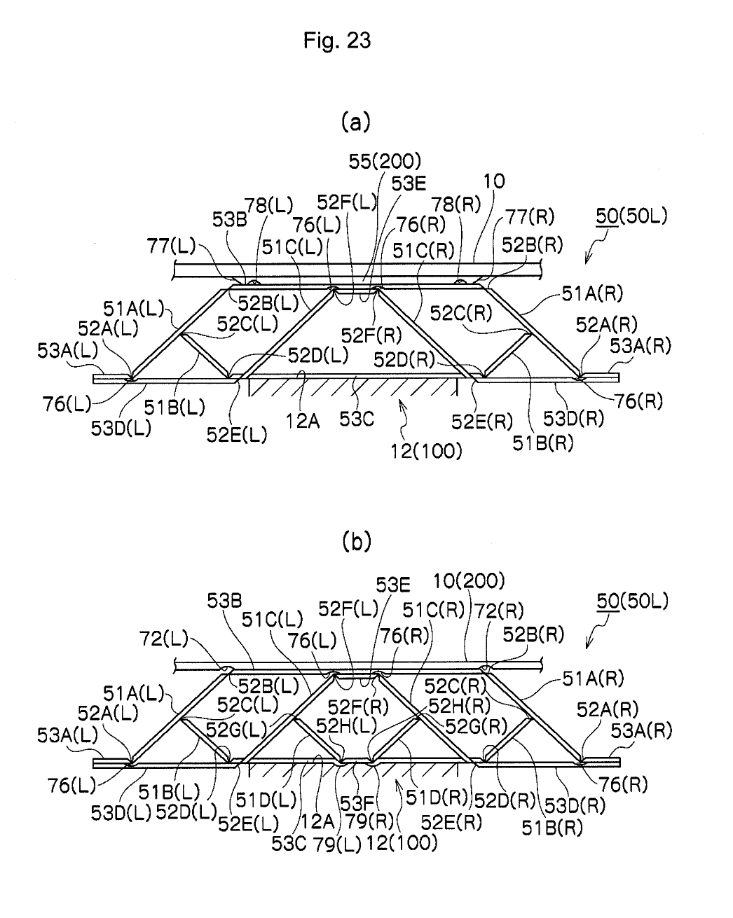

FIGS. 20, 21, 22, and 23 are views illustrating another example of the vibration direction converter part 50 according to an embodiment of the present invention (FIG. 20(a) is a side view, FIG. 20(b) is a perspective view, FIG. 21 is a view illustrating an operation, FIGS. 22(a) and 22(b) are views illustrating an example of forming and FIGS. 23(a) and 23(b) are side views). The vibration direction converter part 50 (link body 50L) is provided with a pair of a driving parts, and the vibration direction converter parts 50 are oppositely arranged substantially symmetrically each other, while a parallel link is formed with a plurality of link parts.

The vibration direction converter part 50 according to this embodiment includes a pair of first link parts 51A (R) and 51A (L) having a hinge part 52A (R) and 52A (L) to a first coupling portion 53A (R) and 53A (L) at one end, and having a hinge part 52B (R) and 52B (L) to a second coupling part 53B at another end. Also, the vibration direction converter part 50 includes a pair of second link parts 51B (R) and 51B (L) having hinge parts 52C (R) and 52C (L) to the middle parts of the first link parts 51A (R) and 51A (L) at one end, and having hinge parts 52D (R) and 52D (L) to the static coupling part 53C at another end. As described above, the first coupling portion 53A is connected to the voice coil 30 or the voice coil support part 40 directly or via the coupling part 60 as other member, while the second coupling part 53B is connected to the diaphragm 10 and the static coupling part 53C is connected to the bottom part 12A of the frame 12 that is the static part 100, the yoke 22, etc. forming the magnetic circuit 20.

Further, the vibration direction converter part 50 includes a pair of third link parts 51C(R) and 51C(L) having hinge parts 52E(R) and 52E(L) at one end to a pair of the coupling parts 53D (R) and 53D (L) integrally extending from the first coupling portion 53A (R) and 53A (L), and having hinge parts 52F (R) and 52F (L) at another end to a coupling part 53E that is integral with the second coupling part 53B.

Further, the first link part 51A (R) and the third link part 51C (R), the first link part 51A (L) and the third link part 51C (L), the second link part 51B (R) and the third link part 51C (L), and the second link part 51B (L) and the third link part 51C (R) form parallel links respectively.

The link body 50L of this vibration direction converter part 50 substantially has a function of the combination with the link body of the embodiment shown in FIG. 13 and the parallel link body, and each of the link parts and the coupling parts are formed by integrating the rigidity member 50Q to the continuous member 50P, and each hinge part between the link parts is linearly formed only with the bendable continuous member 50P, and thus the link parts are integrally formed via hinge parts therebetween.

In the example shown in the drawings, recessed parts 76 are foamed as the contact avoiding part 70 at a second coupling part 53B arranged in the proximity of near and opposite hinge parts 52F (R), 52F (L) and at a pair of coupling parts 53D (R), 53D (L) arranged in the proximity of near and opposite hinge parts 52A (R), 52A (L), such that a space is formed between each hinge part and coupling parts. Further, the total length of the contact avoiding part 70 which is formed at the second coupling part 53B and the pair of coupling parts 53D (R), 53D (L) is formed substantially the same or larger than the widths of the coupling part 53E and the first coupling portion 53A (R), 53A (L) along the contact avoiding part 70.

An operation of the vibration direction converter part 50 is described with reference to FIG. 21. In this embodiment, the static coupling part 53C functions as the static part 100. According to the vibration direction converter part 50, when the hinge parts 52A(R) and 52A(L) is moved from the reference position X0 to X1 in the X axial direction in accordance with vibration of the voice coil support part 40, the second coupling part 53B and the coupling part 53E integrally with the second coupling part 53B moving up keeping a parallel state by the parallel link body, while the first link parts 51A(R) and 51A(L) and the third link parts 51C(R) and 51C(L), which configure a parallel link, are angle-varied as they are erected. Since the hinge parts 52D (R) and 52D (L) are supported at both ends of the static coupling part 53C as the static part, they receive a reaction force from the static part and angle of the first link parts 51A(R) and 51A(L) and the third link parts 51C(R) and 51C(L) is securely varied and the displacement of the hinge parts 52A(R) and 52A(L) from the position X0 to X1 is securely converted to the displacement of the diaphragm 10 from the position Z0 to Z1.

Similarly, when the hinge parts 52A(R) and 52A(L) is moved from the reference position X0 to X2 in the X axial direction, the second coupling part 53B and the coupling part 53E integrally with the second coupling part 53B are moved down keeping a parallel state by the parallel link body, while angles of the first link parts 51A(R) and 51A(L) and the third link parts 51C(R) and 51C(L), which configure a parallel link, are varied as they are laid. Since the hinge parts 52D (R) and 52D (L) are supported by the static part, they receives a reaction force from the static part and angle variation of the first link parts 51A(R) and 51A(L) and the third link parts 51C(R) and 51C(L) is securely produced and the displacement of the hinge parts 52A(R) and 52A(L) from the position X0 to X2 is securely converted to the displacement of the diaphragm 10 from the position Z0 to Z2.

According to this embodiment, the vibration of one voice coil support part 40 in the X axial direction is converted to the vibration in the Z axial direction of the hinge parts 52B (R), (L), 52F(R), (L) and the second coupling part 53B, which vibrate substantially in the same phase and substantially with the same vibration amplitude. Thus, the diaphragm 10 is supported at broad area and the vibration in substantially the same phase and with the same vibration amplitude is transmitted to the diaphragm 10, thereby transmitting the vibration of the voice coil support part 40 substantially in the same phase to the planar diaphragm 10 which has a broad area.

As shown in FIG. 20(b), in the vibration direction converter part 50, a pair of the coupling parts 53B, 53D (R) and 53D (L) and the third link parts 51C (R) and 51C (L) are disposed in a width direction and parallel respectively. The first link parts 51A (R) and 51A (L) are formed in a biforked shape, and the hinge parts 52C (R) and 52C (L) to the second link parts 51B (R) and 51B (L) are formed at the middle parts of the first link parts 51A (R) and 51A (L). The second link parts 51B (R) and 51B (L) and the coupling part 53C are placed between a pair of the coupling parts 53B, 53D (R) and 53D (L) and the third link parts 51C (R) and 51C (L), which are disposed in a width direction and parallel.

With link parts configured with a single sheet-shape component as described above, the diaphragm 10 can be vibrated and supported by a face, and thereby the whole diaphragm 10 can be vibrated substantially in the same phase and divided vibration may be restrained.

Further, as shown in FIG. 20(b), in the vibration direction converter part 50 of this embodiment, the first link parts 51A (R) and 51A (L), and the second coupling parts 53B are configured by folding the whole single sheet-shape component forming the link parts in a protruding-trapezoid shape, while the second link parts 51B (R) and 51B (L), and the static coupling part 53C are configured by folding in a recessed-trapezoid shape and in a partially taken-out portion of this plate component.

A method of configuring this vibration direction converter part 50 is described with reference to FIG. 22. According to one configuration method, this vibration direction converter part 50 is formed by joining a plurality of sheet-shape components 501, 502 (for example, two components) as shown in FIG. 22(a). The first coupling portions 53A (R) and 53A (L), the first link parts 51A (R) and 51A (L), the second link parts 51B (R) and 51B (L), the second coupling parts 53B and the static coupling part 53C are formed in one sheet-shape component 501, while the coupling parts 53D, the third link parts 51C (R) and 51C (L) and the coupling parts 53E are formed in another sheet-shape component 502. And, the third link parts 51C (R) and 51C (L) and the coupling parts 53D (R) and 53D (L) are formed along the first link parts 51A (R) and 51A (L) and the second coupling parts 53B, and an opening 502A is formed in the sheet-shape component 502 corresponding to the second link parts 51B (R) and 51B (L) and the static coupling part 53C.

In this example, the opening 502A, formed in another sheet-shape component 502 corresponding to the second link parts 51B (R) and 51B (L) and the static coupling part 53C of one sheet-shape component 501, is formed so as to expand inward from ends of another sheet-shape component 502. This configuration may prevent the second link parts 51B (R) and 51B (L), and the static coupling part 53C from contacting another sheet-shape component 502, and thus a smooth movement of the link body may be performed.

In the sheet-shaped components 501, 502 formed with the continuous member 50P and the rigid member 50Q, as shown in FIG. 22(b), the two components 501, 502 are connected together with the continuous members 50P facing each other. As such, the continuous members 50P are combined, whereby the hinge part 52 can be smoothly bent. Also, in this case, at the portion in the proximity of and opposite the hinge part 52, a recessed part or a notch part 76 is formed as the contact avoiding part 70.

Further, the slant face as shown in FIG. 9(c) is formed at the end of each link part in vicinity of each hinge part. The slant face is formed such that the link parts do not interfere with each other when they bend at the hinge parts. Thus the link parts can efficiently bend at the hinge parts.

In another configuration example, the above-mentioned sheet-shape component 501 and the sheet-shape component 502 are integrally formed with the sheet-shape component 502 connected to the end of the sheet-shape component 501 as shown in FIG. 22(c). The vibration direction converter parts 50 shown in FIGS. 20 and 21 may be obtained by folding the integrated components along a folding line f in the direction of an arrow. In this example, the vibration direction converter part 50 may be simply configured by applying resin material forming the rigid member 50Q to the whole surface of the continuous member 50P that is a sheet-shaped member, cutting in a V-shape to form each hinge part and the slant faces at both sides thereof, and then forming the above-mentioned notch part 50S and opening 502A and hardening the resin material in the same way as shown in FIG. 19.

Further, when forming each hinge part and the slant faces 51t and 53t at the both sides of the hinge part, the rigid member 50Q may be formed with the resin material and molded at the same time. It is preferable that a cross-sectional V-shape groove or a recessed portion is preliminarily formed in a die, which is used to mold the rigid member 50Q.

Further, in the example shown in FIGS. 23(a), 23(b), a middle part member 55 which is formed with, for example, a resin member and so forth is arranged as the attaching counterpart 200 between the second coupling part 53B and the diaphragm 10. In this middle part member 55, at the position in the proximity of and opposite the hinge part 52B (R), 52B (L), a recessed part or a notch part 77 is formed (recessed part is indicated as an example in the drawing here) as the contact avoiding part 70, whereby a space is formed between each hinge part and the middle part member. Further in the example shown in the drawings, a groove part 78 is formed as a receiving part for receiving adhesive, inner side the recessed part 77, in other words, on the upstream side in the spreading and extending direction of adhesive as a connecting member, whereby adhesive which spreads and extends along with connection may enter into the groove part 78.

Further, in the example shown in FIG. 23(b), no middle part member 55 is provided, and a sixth link parts 51D (L), 51D (R) corresponding to the second link parts 51B (L), 51B (R) in FIG. 22(a) are provided between third link parts 51C(L), 51C (R) and the frame 12 as the static part. One end parts of the sixth link parts 51D (L), 51D (R) are connected to the middle parts of the third link parts 51C (L), 51C (R) while the other end parts of the sixth link parts 51D (L), 51D (R) are connected to the bottom part 12A of the frame 12 via the coupling part 53F. Hinge parts 52G (L), 52G (R), 52H (L), 52H (R) are provided between the third link part 51C (L) and the one end part of the sixth link part 51D (L), between the third link part 51C (R) and the one end part of the sixth link part 51D (R), between the other end part of the sixth link part and the coupling part 53F, and between the other end part of the sixth link part 51D (R) and the coupling part 53F. Further, in the bottom part 12A of the frame 12, a recessed part or a notch part is formed as the contact avoiding part 70 in proximity of and opposite the hinge parts 52G (L), 52G (R), and recessed parts 79(L), 79(R) are formed in an example shown in the drawing. Further, the middle part member 55 may be interposed between the diaphragm 10 and the coupling part 53E.

In the embodiments shown in FIGS. 14 to 23, a single integral component is used with respect to two oppositely disposed voice coil support parts 40 whereby the link body of the vibration direction converter part can be formed. Similarly, when a speaker device provided with a pair of driving parts is formed, assembling process can be simply implemented. Also, with the stationary coupling part 53C, the positions of the hinge parts 52D (R), (L) are constantly held without supporting the hinge parts 52D (R), (L) at the frame 12 with respect to opposing vibration of the voice coil support parts 40 (a plurality of voice coil support parts 40 vibrating in the opposite directions each other), and thus incorporation of the vibration direction converter part into a speaker device can be simplified.

Further, in the embodiments shown in FIGS. 20 to 23, parallel links are formed as a link body with the right side first link part 51A (R) and the third link part 51C (R), and the left side first link part 51A (L) and the third link part 51C (L), whereby the second coupling part 53B which is fixed to the diaphragm 10 can be stably moved in parallel in the Z axial direction with respect to the opposing vibration of the voice coil support parts 40. As such, a stable vibration can be applied to the plane shaped diaphragm 10.

For such speaker devices 1, 1A, 1B according to embodiments of the present invention, when an audio signal SS is inputted, the voice coil 30 vibrates along the magnetic gap 20G which is formed in the direction different from the vibration direction in which the diaphragm 10 is allowed to vibrate, and the vibration is direction-converted by the vibration direction converter part 50 and transmitted to the diaphragm 10 to vibrate the diaphragm 10, thereby emitting a sound in response to the audio signal SS in the sound emission direction SD.

Since the direction of the magnetic gap 200 is crossed by the vibration direction of the diaphragm 10 and the thickness direction of the speaker devices 1, 1A, 1B, increasing the driving force of the magnetic circuit 20 or the amplitude of vibration of the voice coil 30 has little effect directly on the size in the thickness direction (Z axial direction) of the speaker devices 1, 1A, 1B. As such, the speaker devices 1, 1A, 1B can be made thin while pursuing loud sound.

Further, since the vibration direction converter part 50 converts the vibration direction of the voice coil support part 40 and transmits the vibration to the diaphragm 10 by a mechanical link body, transmission efficiency of vibration is high. Particularly, in the speaker devices 1A, 1B, 1C, 1D, 1E according to embodiments as shown in FIGS. 13 to 17, since the angle conversion of the first link part 51A and the second link part 51B is performed by the vibration of the voice coil support part 40 and a reaction force from the static part 100, the vibration from the voice coil support part 40 can be more reliably transmitted to the diaphragm 10. As such, preferable reproduction efficiency of the speaker devices 1A, 1B, 1C, 1D, 1E can be obtained.

Further, for the speaker devices 1, 1A, 1B according to embodiments shown in FIGS. 2, 13 and 14, with the coupling part 60, a step can be formed between the position at the end part of the voice coil 30 or the voice coil support part 40 and the position at the end part 50A of the vibration direction converter part 50. Therefore, the width (height) in the Z axial direction of the magnetic circuit 20 can be included in the height of the vibration direction converter part 50, and thus the speaker devices 1 to 1B can be made thin while keeping sufficient height of the magnetic circuit 20 required for securing a driving force. Further, with the coupling part 60, a required height (length of link part 51) of the vibration direction converter part 50 can be sufficiently secured even after the speaker devices 1 to 1B can be made thin, whereby the amplitude of vibration of the diaphragm 10 can be comparatively increased.

Further, the bottom part 61 of the coupling part 60 is foamed so as to slide at a given distance over the bottom part 12A of the frame 12 or the static part 100, whereby the vibration of the voice coil support part 40 can be stabilized. Also, since the end part of the vibration direction converter part 50 can be linearly moved, the movement of the end part 50B of the vibration direction converter part 50 which is connected to the diaphragm 10 can be reliably stabilized.

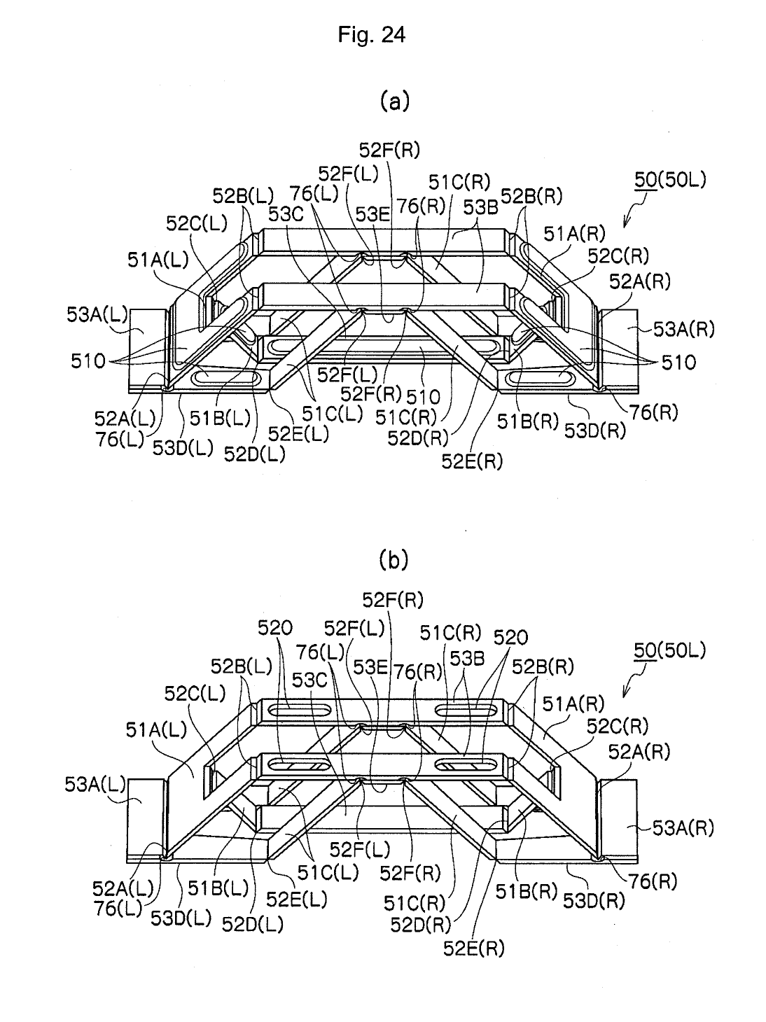

The embodiment shown in FIG. 24 is an example of improvement of the embodiment shown in FIG. 20. In the example shown in FIG. 24(a), a protruding part 510 is provided to increase rigidity of the link part which is subjected to bend due to the opposite vibration of the voice coil support part 40. In the example shown in the drawing, the protruding parts is provided at each of the first link parts 51A (R), (L), the second link parts 51B (R), (L), the coupling parts 53D (R), (L), and the coupling part 53C respectively. Further, in the example shown in FIG. 24(b), the vibration direction converter part is weight-reduced by providing an opening 520 at the link part which particularly do not require strength. In the example shown in the drawing, the openings 520 are provided at the coupling part 53B. The weight-reduction of the vibration direction converter part is effective in particular for broadening reproduction property or increasing vibration amplitude of sound wave and sound pressure level for predetermined voice currents.

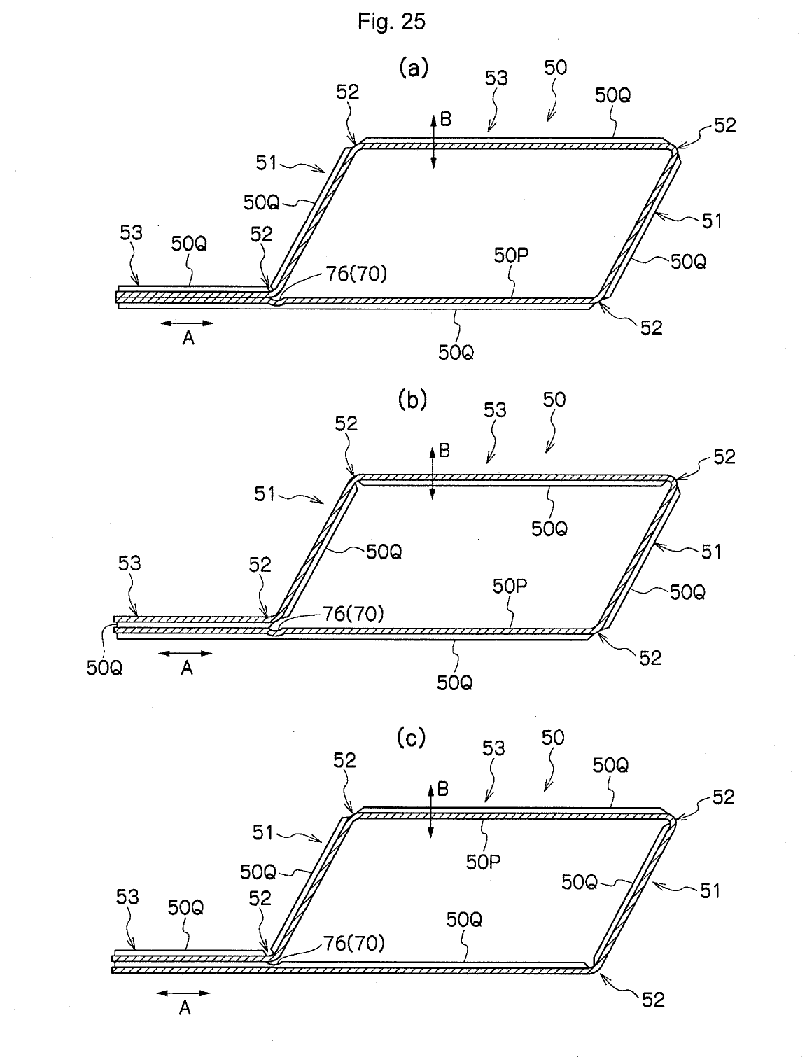

FIG. 25 shows a variation of the vibration direction converter part 50. The vibration direction converter part 50 includes a pair of hinge parts 52 which are adjacently arranged each other in the direction of the vibration of the voice coil (arrow A direction) and a straight line connecting the pair of hinge parts 52 is substantially in parallel with the direction of the vibration of the voice coil (arrow A direction). The link body of this vibration direction converter part 50 includes at least four hinge parts 52, and the link parts 51 and the coupling parts 53 between the four hinge parts form a parallelogram and the hinge parts 52 are disposed near the corners of the parallelogram.

Here, in the example shown in FIG. 25(a), the pair of hinge parts 52 is arranged on the same surface side as the rigid member 50Q. Further, all the hinge parts 52 are formed inside the rigid member 50Q. As such, a parallelogram is easily formed by the continuous member 50P, and a parallel link allowing a smooth movement can be formed with the hinge parts 52 which are formed with the continuous member 50P and arranged at the corners of the parallelogram. Also in this case, at the position of the rigid member 50Q which is in the proximity of near and opposite the hinge part 52, a recessed part or a notch part 76 is formed as the contact avoiding part 70. Also, the hinge part 52 can be formed outside the rigid member 50Q.

In contrast, in FIGS. 25(b), 25(c), the hinge part 52 are formed inside or outside the rigidity member 50Q. As such, when the continuous member 50P is connected, the rigidity member 50Q may be provided between the continuous members 50P, and the length of the rigidity member 50Q is required to be adjusted in order to accurately form the parallelogram with the continuous member 50P.

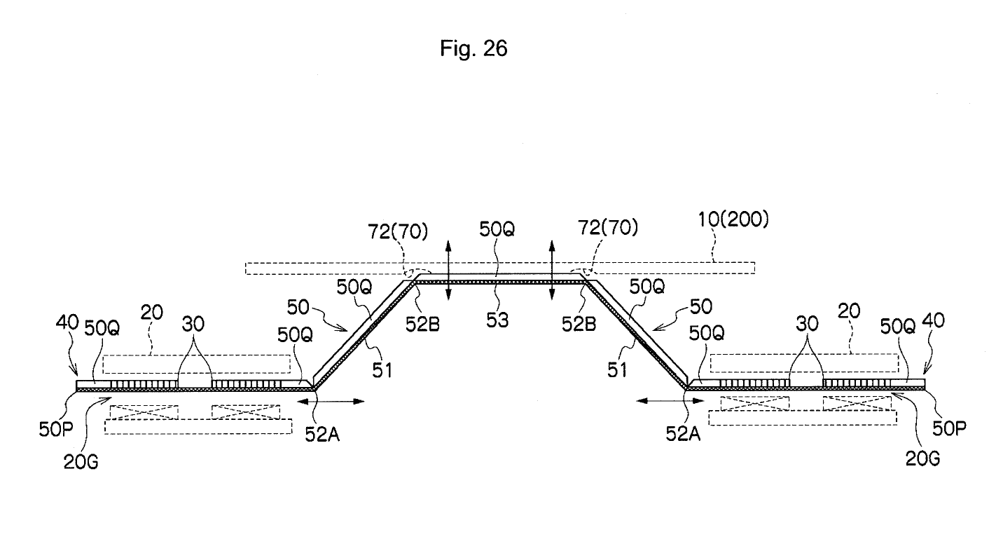

FIG. 26 is a view illustrating a speaker device according to another embodiment of the present invention. In this embodiment, the vibration direction converter part 50 and the voice coil support part 40 are integrally formed, and the link part 51 of the vibration direction converter part 50 and the voice coil support part 40 are formed such that the continuous member 50P and the rigidity member 50Q are laminated, and in the voice coil support part 40, the voice coil 30 is supported inside the rigidity member 50Q or on the face of the rigidity member 50Q.

As shown in the drawing, when a pair of driving parts is oppositely disposed, the continuous member 50P is continuously extended from one side voice coil support part 40 to other side voice coil support part 40 via link part 51 of one side of the vibration direction converter part 50, the coupling part 53 to the diaphragm 10, and the link part 51 of other side of the vibration direction converter part 50. And, rigidity member 50Q is integrally stacked to the face of the continuous member 50P except for the hinge parts 52A, 52A. The voice coil 30 is supported inside or on the face of the rigidity member 50Q in the voice coil support part 40 which is disposed in the magnetic gap 200 of the magnetic circuit 20.

According to such an embodiment, the voice coil support part 40 and the vibration direction converter part 50 are integrally formed whereby assembly of components in a speaker device can be simplified. Also, by integrally forming the voice coil support part 40 and the vibration direction converter part 50, the vibration of the voice coil 30 can be efficiently transmitted to the diaphragm 10 via the vibration direction converter part 50, that is, vibration transmission efficiency can be improved.

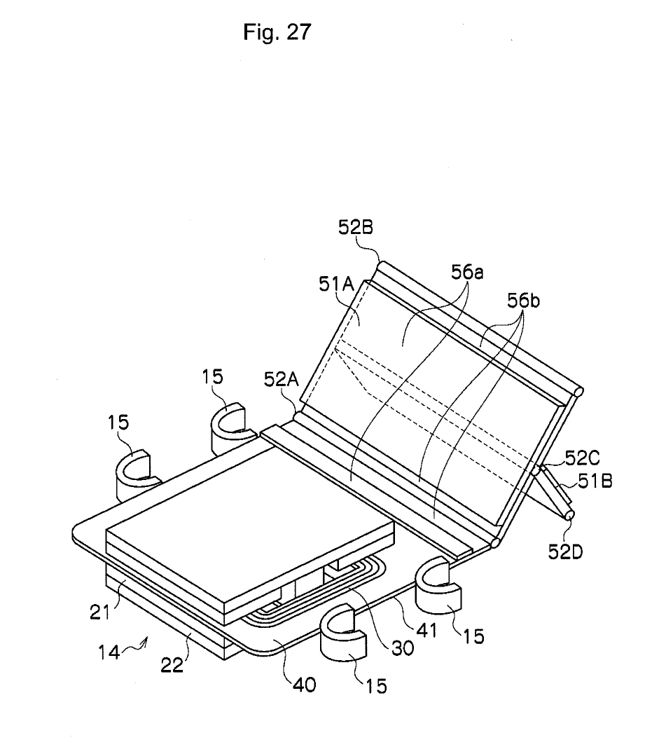

FIGS. 27 to 30 are views illustrating another example of the driving part 14 according to embodiments of the present invention (FIGS. 27 to 30 are partial perspective view). In the example shown in FIG. 27, a comparatively thick part 56a and a comparatively thin part 56b are formed at a part of the link parts 51 (51A, 51B) of the vibration direction converter part 50 and at a part of the voice coil support part 40. The thick part 56a and a thin part 56b are sequentially disposed in the vibration direction of the voice coil 30, whereby bending rigidity of the link parts 51 (51A, 51B) and the voice coil support part 40 is reduced and spring property is generated. Thus, an unwanted peak and dip on output sound pressure characteristic in a speaker device can be prevented from being generated near the high frequency limit (mechanical high-cut function is generated). Further, the thick part 56a may be formed by joining another member with rigidity to the member constituting the link part 51 (51A, 51B). The symbols 15 in the drawings represent the aforementioned holding parts.

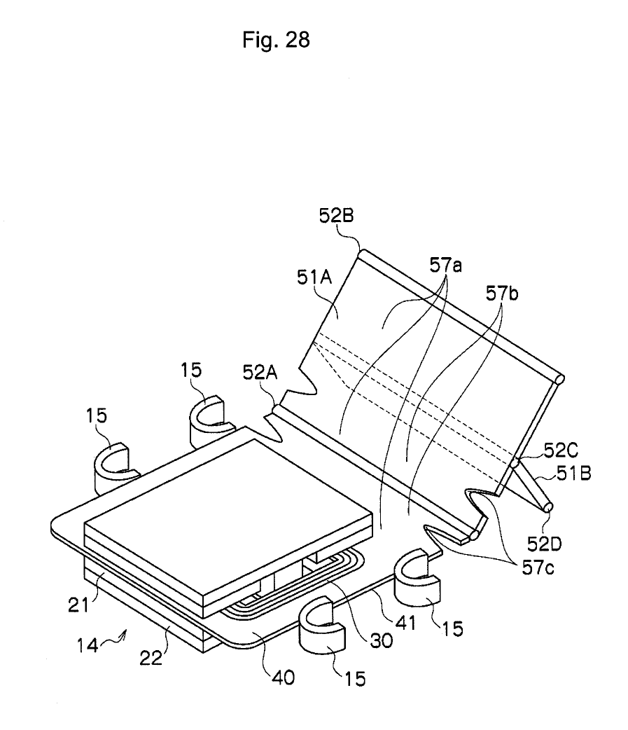

In the example shown in FIG. 28, a comparatively wide part 57a having a comparatively wide shape and a comparatively narrow part 57b having a comparatively narrow shape are formed at a part of the link part 51 (51A) and at a part of the voice coil support part 40. As shown in the example, recessed shaped notch parts 57c are formed at the end edges of the link part 51 (51A) and the voice coil support part 40. By forming the notch parts 57c, the wide part 57a and the narrow part 57b are sequentially disposed in the vibration direction of the voice coil 30, whereby regions with large rigidity and regions with small rigidity are generated in the link part 51 (51A) and the voice coil support part 40. As such, bending rigidity of the link part 51 (51A) and the voice coil support part 40 is reduced and spring property is generated. Thus, an unwanted peak and dip on output sound pressure characteristic in a speaker device can be prevented from being generated near around the high frequency limit.

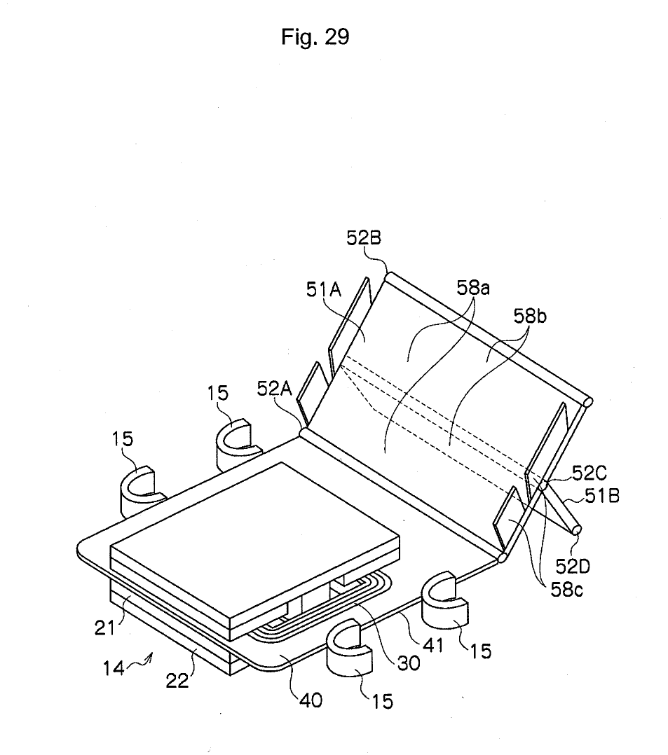

In the example shown in FIG. 29, reinforced parts 58a and non-reinforced parts 58b are provided on the link part 51 (51A). In the indicated example, folded parts 58c are formed at the end edge of the link part 51 (51A). Reinforced parts 58a and non-reinforced parts 58b are sequentially disposed in the vibration direction of the voice coil 30, whereby regions with large rigidity and regions with small rigidity are generated in the link part 51 (51A). As such, bending rigidity of the link part 51 (51A) is reduced and spring property is generated. Thus, an unwanted peak and dip on output sound pressure characteristic in a speaker device can be prevented from being generated near the high frequency limit.

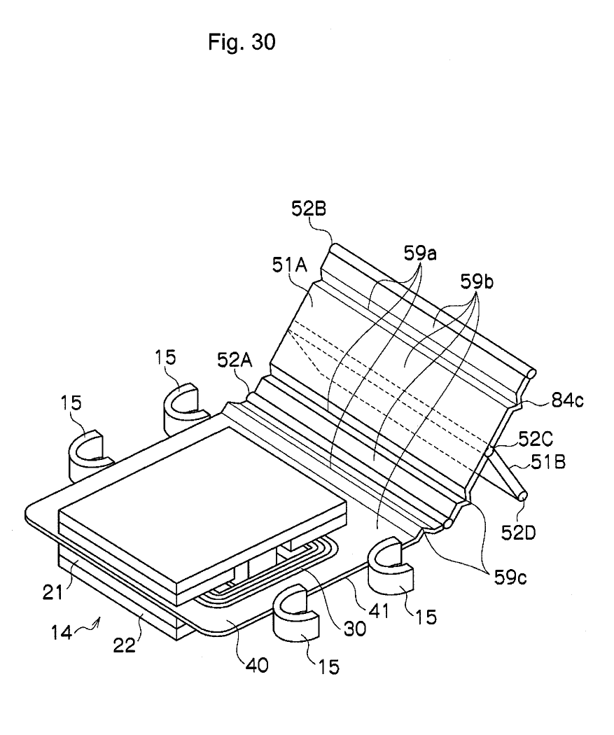

In the example shown in FIG. 30, spring parts 59a as parts formed comparatively transformable and non-spring parts 59b as parts formed comparatively undeformable are sequentially provided at the link part 51 (51A) and at the voice coil support part 40 in the vibration direction of the voice coil 30. As indicated in the example, protrusion parts or groove parts 59c are formed at the link parts 51 (51A) and the voice coil support parts 40 in the direction crossing the vibration direction of the voice coil 30. In other words, a plurality of steps is disposed in the vibration direction of the voice coil 30. As such, regions with large rigidity and regions with small rigidity are generated in the link part 51 (51A) and the voice coil support part 40, and bending rigidity of the link part 51 (51A) is reduced and spring property is generated. Thus, an unwanted peak and dip on output sound pressure characteristic in a speaker device, can be prevented from being generated near the high frequency limit. Further, in order to generate spring property in the entire driving part, the coupling portion may be configured with an elastic member with respect to the link part 51 (51A) and the voice coil support part 40. Further, the hinge part 52 may have spring property by providing the hinge member 52g shown in FIG. 11(d) with a damping material or grease which is formed with polyurethane resin having foam structure or silicone resin and so forth.

### Embodiment and Carrying Example

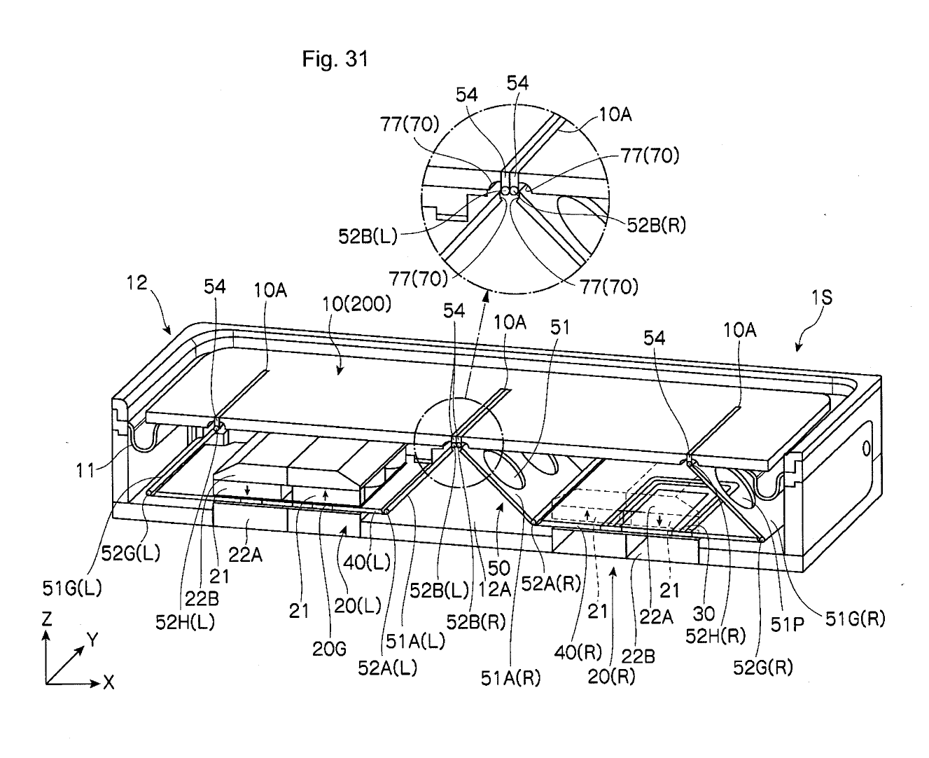

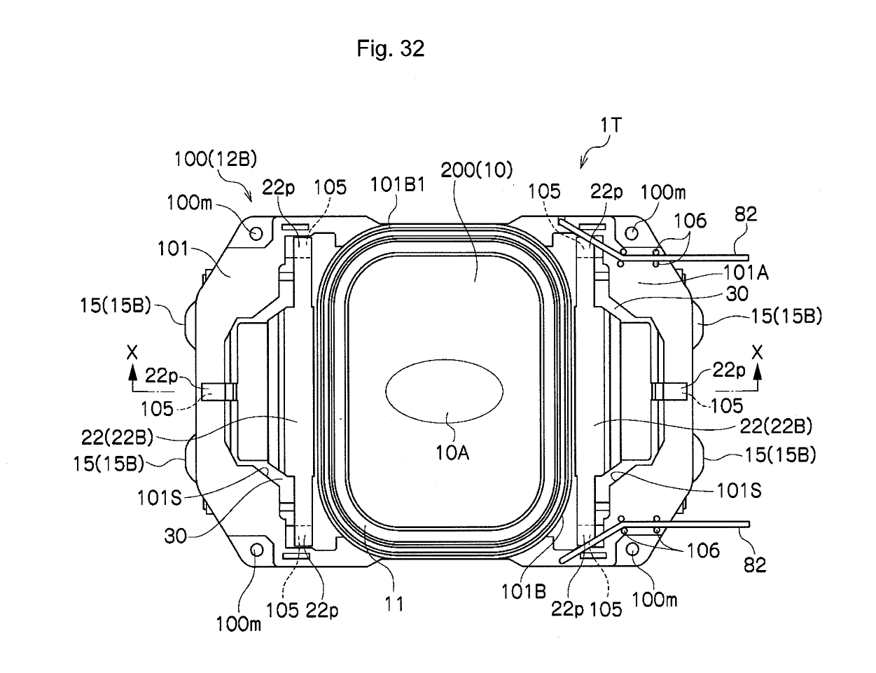

### FIG. 31, FIGS. 32 to 42

Hereinafter, an embodiment of the present invention is described with reference to the drawings. FIG. 31 is a view illustrating a speaker device 1S according to an embodiment of the present invention (FIG. 31 is a cross-sectional perspective view). The part having a common description with the previously described part bears the same symbol and the duplicate description is omitted. In the speaker device 1S, a connecting part 54 is formed on one end side of the vibration direction converter part 50 via a hinge part 52 and this connecting part 54 is inserted into a hole part 10A (slit) which is formed in the diaphragm 10 and are connected to the diaphragm 10, and the contact avoiding part 70 is formed in the proximity of the hinge part 52.

As indicated in the example, the vibration direction converter part 50 is provided respectively at both ends in the vibration direction of a pair of the voice coils 30 or the voice coil support parts 40, in a pair of the voice coils 30 or a pair of the voice coil support parts 40, which is driven by a pair of magnetic circuits 20(R), 20(L), a pair of the first link parts 51A (R), 51A(L) is provided in the center and auxiliary link parts 51G (R), 51G (L) are provided outside each voice coil 30. The first link parts 51A (R), 51A (L) are bendably connected at the central part (gravity point) of the diaphragm 2 via the hinge parts 52B (R), 52B (L). The auxiliary link parts 51G (R), 51G(L) are bendably connected to the diaphragm 10 at the position on the outer periphery side of the central part (gravity point) via the hinge parts 52H (R), 52H (L). The auxiliary link parts 51G (R), 51G (L) may not be provided as necessary.

Further, the connecting parts 54 are formed near upper end parts of the first link parts 51A (R), 51A (L) and the auxiliary link parts 51G (R), 51G(L), and each connecting part 54 is inserted into the hole part 10A which is formed in the diaphragm 10 and connected to the diaphragm 10, for example by a coupling member such as adhesive and a double face tape or a connecting member such as a fastening member, whereby, for example, the connecting parts 54 are fixed to the diaphragm 10 respectively, while protruding from or being flush with the front surface of the diaphragm 10. Further, in the hole parts 10A of the diaphragm 10, at positions in the proximity of and opposite the hinge parts 52B (R), 52B (L) and the hinge parts 52H (R), 52H (L), recessed parts or notch parts 77 are formed as the contact avoiding part 70, whereby a space is formed between the diaphragm and each of hinge parts. Further, on the face side opposite the hinge parts 52B (L), 52B (R) in the first link parts 51A (R), 51A (L), a recessed part or a notch part 77 is formed as the contact avoiding part 70. Further, in the voice coil support part 40, at the end edges of the auxiliary link parts 51G (R), 51G (L) and the end edges of the first link parts 51A (R), 51A (L), notch parts are formed to prevent having contact with adjoining auxiliary link parts 51G (R), 51G (L) and first link parts 51A (R), 51A (L).

As such, the diaphragm 10 is linearly supported by the vibration direction converter part 50 at different plural positions. Also, the linear connecting end part 54 is embedded inside the diaphragm 10 as a reinforcing member, the diaphragm 10 has comparatively large strength, thereby preventing the diaphragm from being bent. Also, the entire diaphragm 10 can be vibrated substantially in the same phase.

Further, the first link parts 51A (R), 51A (L) and the auxiliary link parts 51G (R), 51G (L) form two opposing parallel links, whereby a plurality of connecting parts may vibrate substantially in the same phase and substantially with same amplitude in response to the opposing vibrations (a plurality of the voice coils 30 vibrating in the directions opposite each other) of the voice coils 30. As such, the entire diaphragm 10 vibrates substantially in the same phase, thereby occurrence of divided vibration (including divided resonance) can be suppressed.

Venting holes 51, 51P are provided on the first link parts 51A (R), 51A (L) and the auxiliary link parts 51G(R), 51G(L) thereby reduction in weight and air resistance of each link part can be realized.

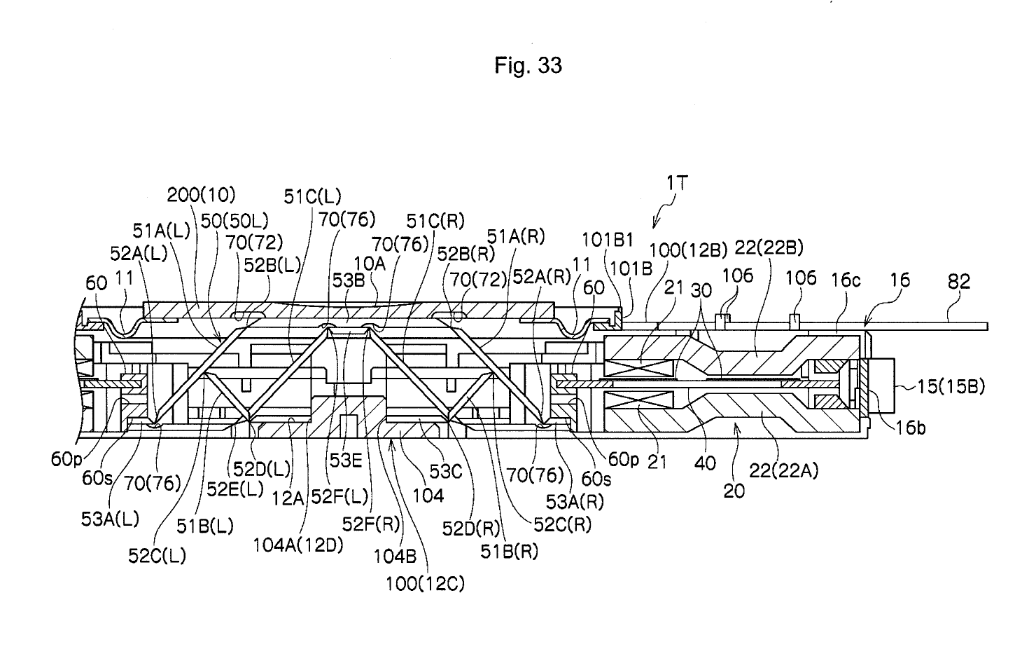

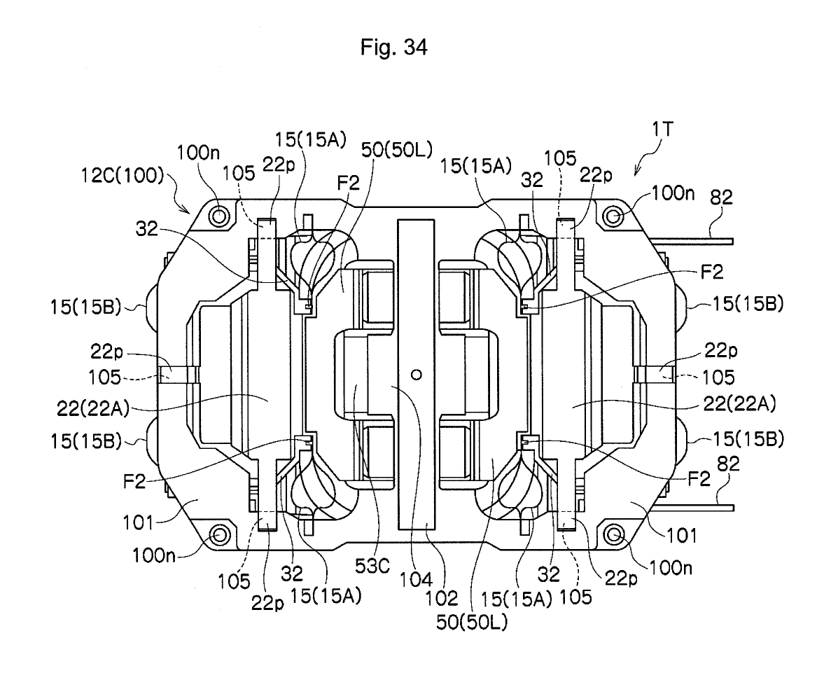

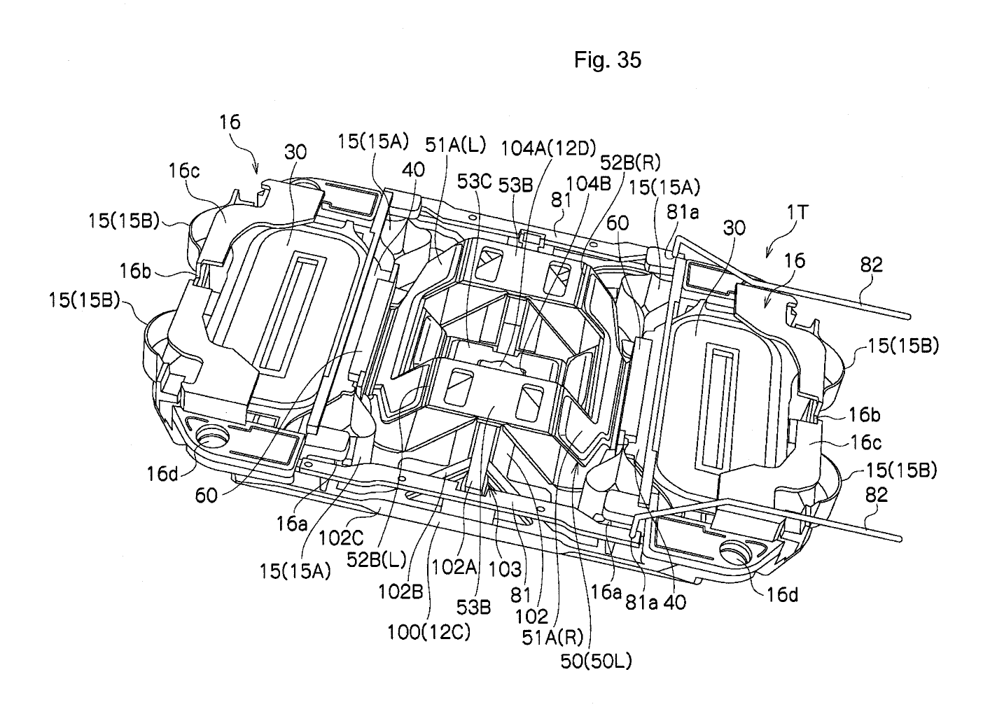

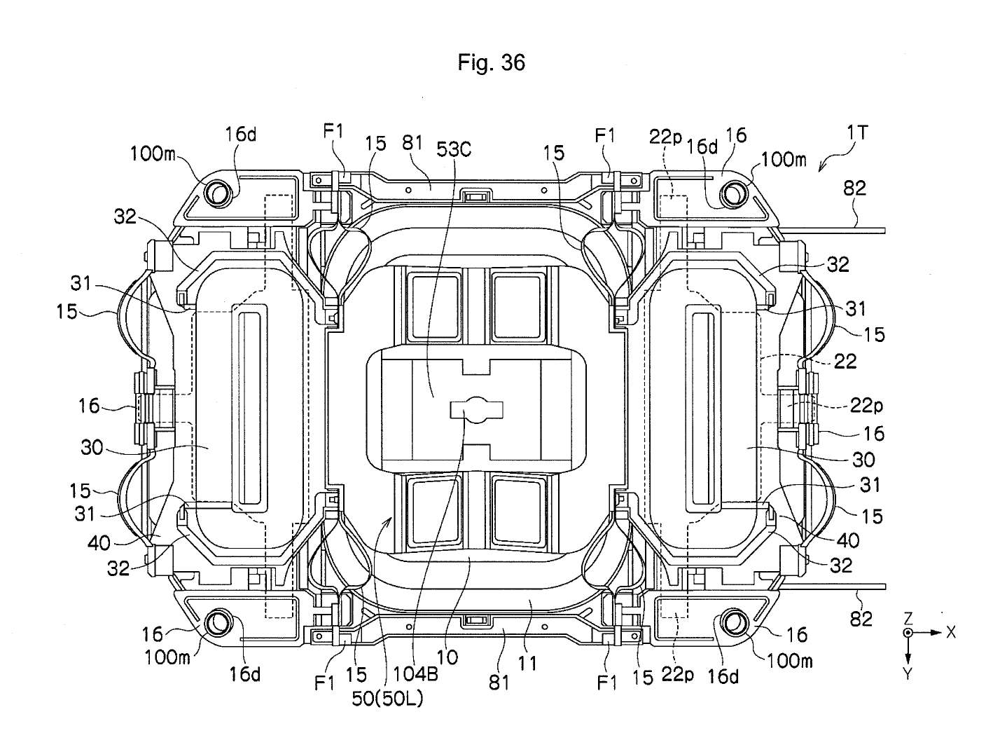

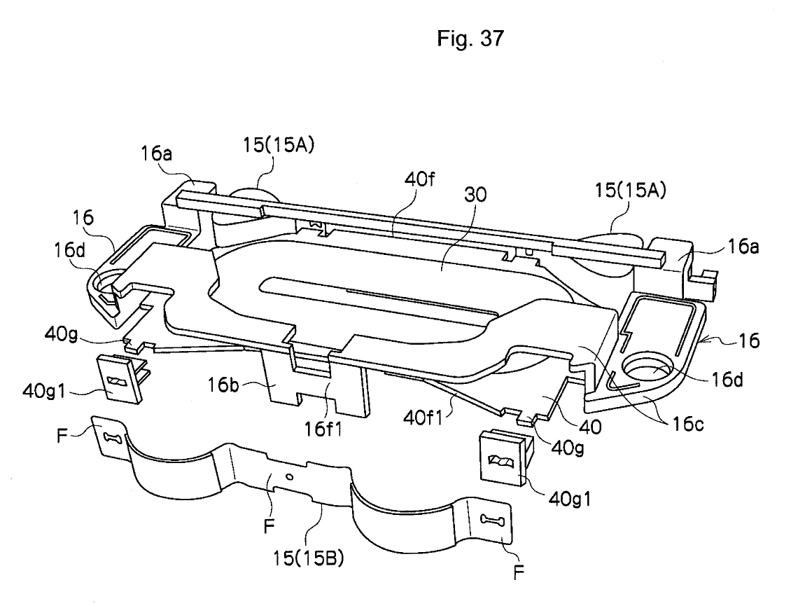

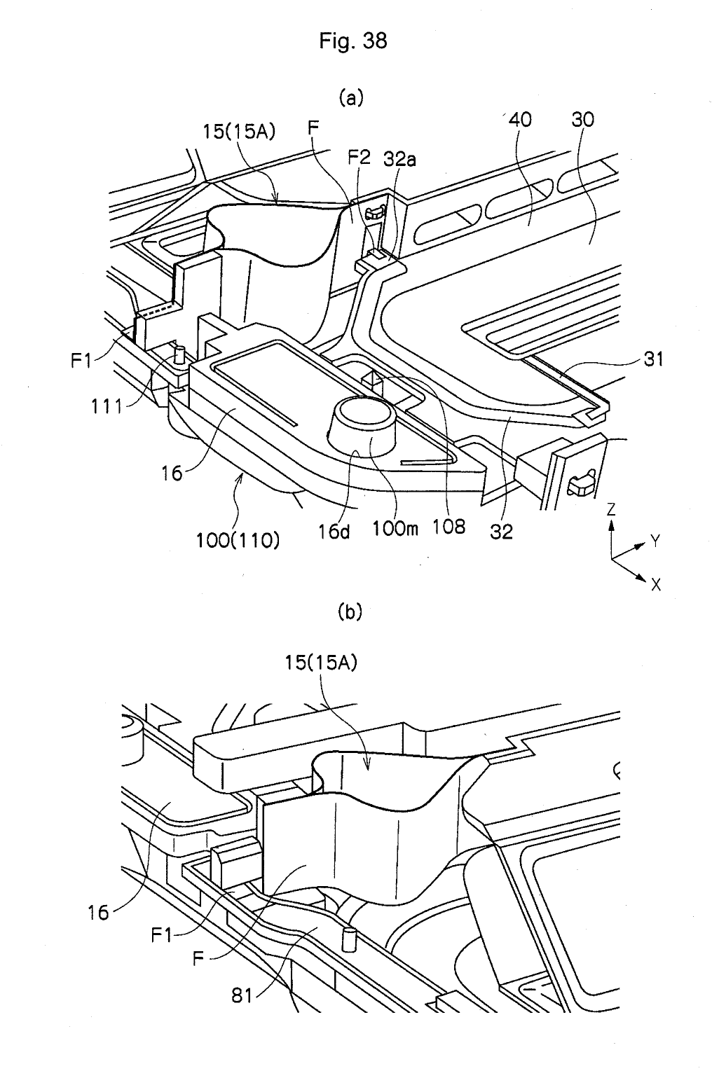

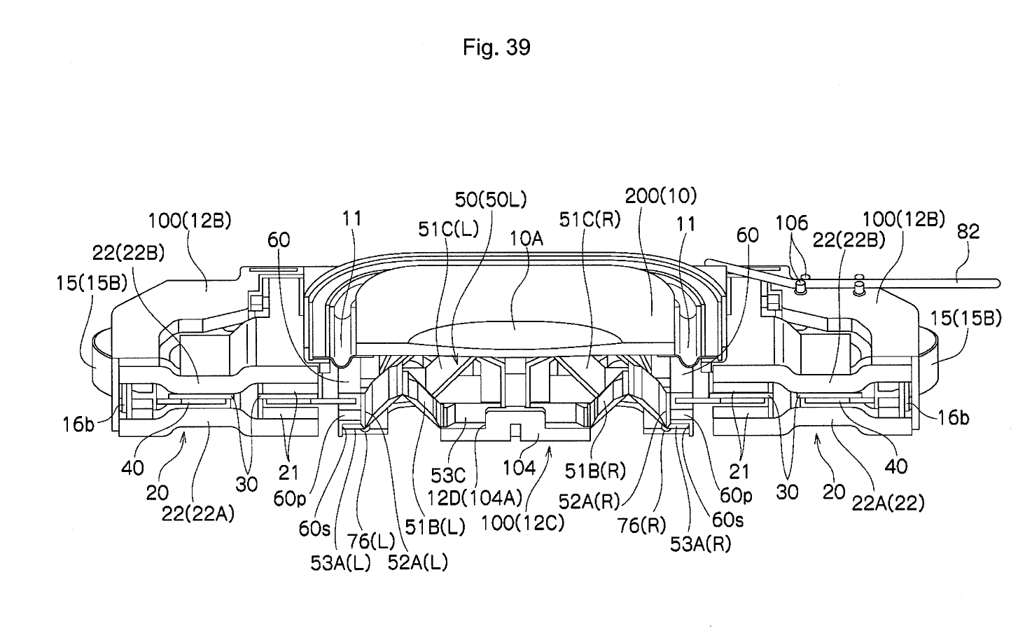

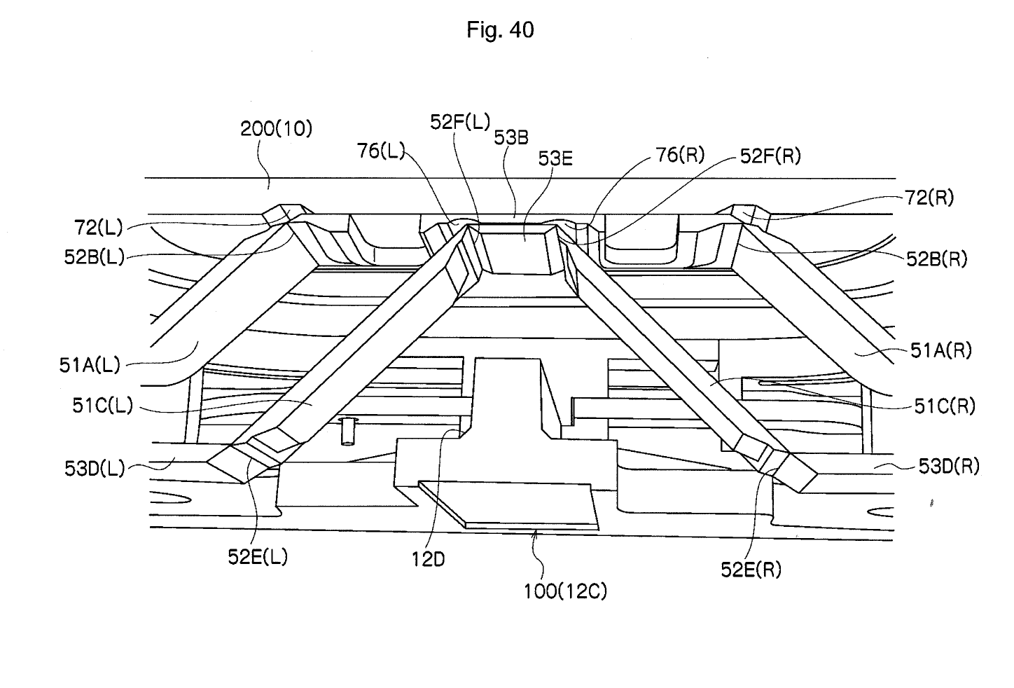

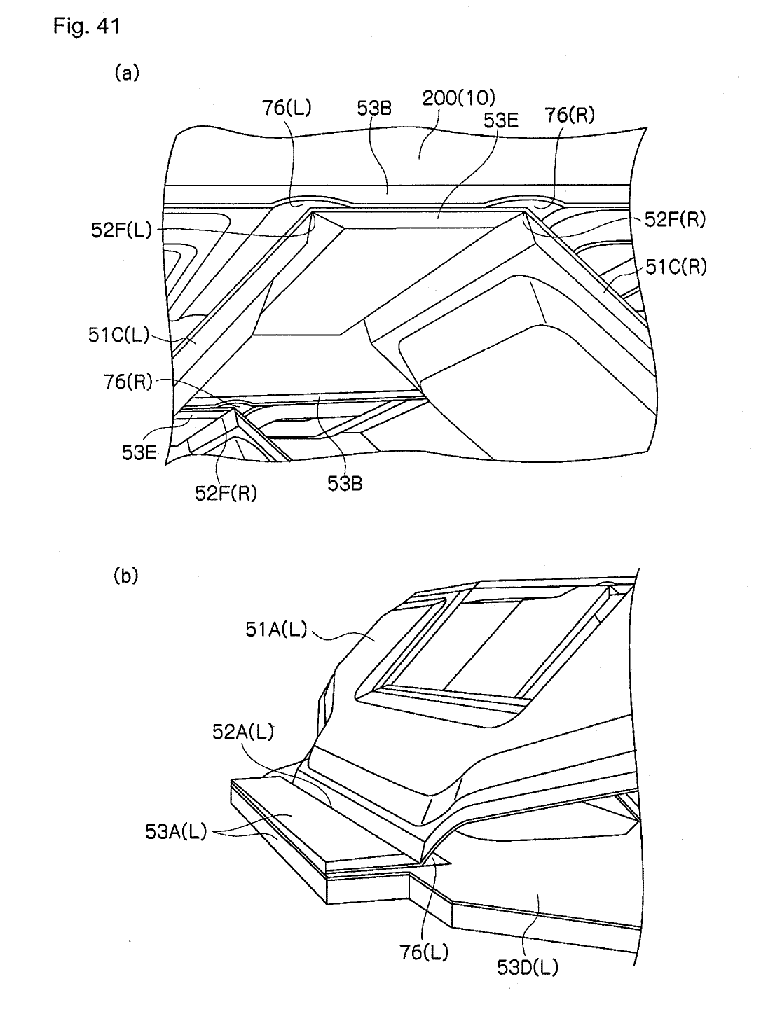

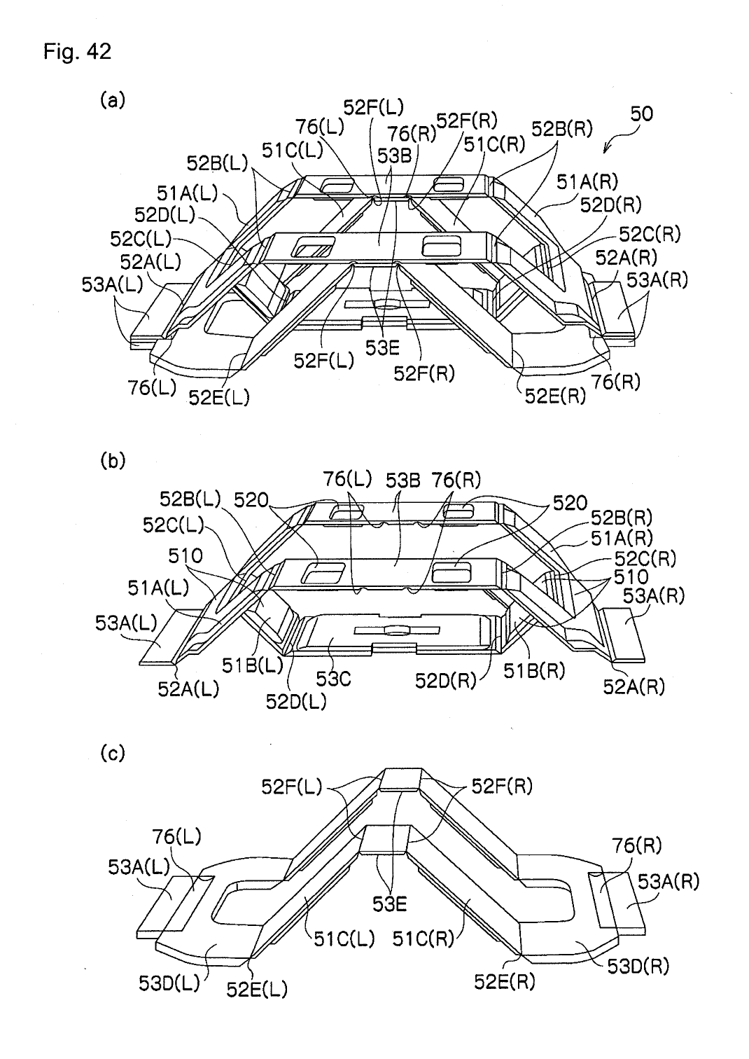

FIGS. 32 to 42 are views illustrating a speaker device 1T according to another embodiment of the present invention (FIG. 32 is a plan view, FIG. 33 is a cross-sectional view taken along line X-X, FIG. 34 is a back view, FIG. 35 is a perspective view without a first configuration member, FIG. 36 is a bottom view without a second configuration member, FIG. 37 is an exploded perspective view of an essential part, FIGS. 38(a), 38(b) are partially enlarged cross-sectional perspective views of an essential part, FIG. 39 is a cross-sectional perspective view, FIGS. 40, 41(a) are partially enlarged cross-sectional perspective views of an essential part, FIG. 41(b) is a partially enlarged perspective view of an essential part, FIG. 42(a) is a perspective view of the entire vibration direction converter part 50, and FIGS. 42(b), 42(c) are exploded perspective views of the vibration direction converter part 50). The part having a common description with the previously described part bears the same symbol and the duplicate description is partially saved. The example shown in FIG. 20 and FIG. 21 is adopted as the vibration direction converter part 50.

According to the example shown in FIG. 32, the diaphragm 10 is formed in a rectangular shape viewed from the sound emission direction, and a curved part 10A with elliptical outer shape and recessed cross-sectional shape is formed near the central part, and thus the diaphragm 10 has a predetermined bending rigidity in the vibration direction of the diaphragm 10 and the vibration direction of the voice coil 30. Further, with the recessed shaped curved part 10A formed at the diaphragm 10, density of the curved part 10A becomes larger than other part of the diaphragm 10 and thereby rigidity may be made comparatively large. Further, when a pair of the vibration direction converter parts 50 are arranged opposite each other, the curved part 10A is formed between a pair of the hinge parts 52B which are formed between the vibration direction converter part 50 and the diaphragm 10.

Since the diaphragm 10 has rigidity (bending rigidity included) in the vibration direction of the diaphragm, generation of deflection, etc. of the diaphragm 10 may be restrained, and thus generation of difference in phase between sound waves, deterioration of acoustic characteristic, etc. may be restrained. Further, with the curved part 10A of the diaphragm 10 formed between a pair of the hinges 52B that is formed between the vibration direction converter part 50 and the diaphragm 10, generation of deflection may be restrained.

Further, the diaphragm 10 is formed substantially in a rectangular shape including a short axis extending in the vibration direction of the voice coil 30 and a long axis extending along the direction orthogonal to the vibration direction of the voice coil 30, a reinforcing part (not shown) may be formed in the direction of the long axis or the short axis. The reinforcing part includes a groove part, having, for example, V-shaped cross-section, which is formed linearly, annularly or in a lattice shape in the front face or rear face of the diaphragm 10. For example, filling material such as damping material may be applied to inside of the groove part. As such, with the groove part filled by the filling material, rigidity (bending rigidity included) of the diaphragm 10 may be increased and the peak and dip of sound pressure frequency characteristic of a speaker may be lowered. Further, as another example of the reinforcing part, for example, fiber member made of unwoven fabrics (not shown), etc. may be applied instead of forming the groove part. With the reinforcing part constructed with the fiber member as described above, rigidity (bending rigidity) of the diaphragm 10 may be increased, and thus generation of deformation such as deflection in the diaphragm 10 due to vibration or air resistance transmitted from the vibration direction converter part when the diaphragm 10 vibrates, may be restrained. Further, provided with the reinforcing part, an internal loss of the diaphragm 10 may be improved.

Further, the diaphragm 10 is formed with a first layer constructed with foamed resin including acrylic resin, etc. and a second layer including a fiber member such as a glass fiber, configuring a stacking structure in which the first layer is sandwiched between a pair of the second layers. As a forming material of the diaphragm 10, for example, resin material, metal material, paper material, fiber material, ceramics material, compound material, etc. may be adopted.

The edge 11, vibratably supporting the diaphragm 10 at the frame 12 as the static part 100, is arranged between the diaphragm 10 and the frame 12, and the inner periphery part supports the outer periphery part of the diaphragm 10 while the outer periphery part is connected to the frame 12 directly or via other member, and thus the diaphragm 10 is held at a prescribed position. As other member, elastic member functioning as a packing (including resin member), adhesive resin, etc. are included. More specifically, the edge 11 vibratably supports the diaphragm 10 in the vibration direction (Z axial direction), and restrains vibration in the direction orthogonal to the vibration direction (Y axial direction). The edge 11 is formed in a ring shape (annular shape) viewed from the sound emission direction, and the cross-section of the edge 11 is formed in a prescribed shape, for example, a recessed shape, projecting shape, corrugated shape, etc. in the sound emission direction. As the forming material of the edge 11, conventional material, for example, fur, cloth, rubber, resin, a filler-applied member with a material such as fur, cloth, rubber or resin, rubber member or resin member molded in a prescribed shape, may be adopted. Further, in a part or whole circumference of the edge 11, a projection part projecting from the front face (in the sound emission direction), or from the rear face (in the direction opposite to the sound emission direction) or a recessed part may be formed, rigidity of the edge 11 in a prescribed direction may be increased.

The static part 100 is divided into the first component member 12B and the second component member 12C, and the diaphragm 10 is supported by a central opening part of the first component member 12B via the edge 11. The magnetic circuit 20 can be divided into two parts arranged in the upper side and the lower side of the voice coil 30, and one part of the magnetic circuit in the upper side is supported by the first component member 12B and another part in the lower side is supported by the second component member 12C. In the example shown in the drawing, a yoke part 22B in the upper side of the first component member 12B and a yoke part 22A in the lower side of the second component member 12C are supported so as to be parallel to each other.

The static part 100 includes an outer peripheral frame part 101 surrounding the diaphragm 10 and a bridge part 102 bridging inside of the outer peripheral frame part 101. The bridge part 102 exerts a reaction force on the above link body 50L (vibration direction converter part 50), and has rigidity in the vibration direction of the link body 50L.

As described above, upon vibration of the voice coil 30, the vibration is transmitted to the diaphragm 10 via the link body 50L. At this time, the link body 50L angle-converting the link part 51 is subjected to a reaction force exerted by the diaphragm 10. When the link body 50L is subjected to this reaction force, if the static part 100 supporting the link body 50L is deflected, the link body 50L itself vibrates, and thus the link body 50L may transmit unwanted vibration to the link part 51. When the unwanted vibration transmitted to the link part 51 is transmitted to the diaphragm 10, the vibration of the voice coil 30 may not be efficiently transmitted to the diaphragm 10. Accordingly, the bridge part 102, which is a part of the static part 100 supporting the link body 50L, is provided with a function of restraining generation of deflection, and thus unwanted vibration that may be transmitted to the link part and the diaphragm 10 may be restrained. As such, vibration of the voice coil 30 may be efficiently transmitted to the diaphragm 10.

In order that the bridge part 102 supporting the link body 50L may have rigidity against a force exerted by the diaphragm 10 via the link body 50L, compliance of the bridge part 102 is preferably substantially the same or smaller than compliance of the outer peripheral frame part 101 in the vibration direction of the diaphragm 10. More specifically, thickness of the bridge part 102 is preferably substantially the same or larger than thickness in a part of the static part 100 supporting the diaphragm 10 or the magnetic circuit 20.

In the example shown in the drawing, the bridge part 102 provided at the second component member 12C has a first projection part 102A projecting in the direction that the bridge part extends and in the vibration direction of the diaphragm 10. This first projection part 102A includes a rib structure formed in a longitudinal direction of the bridge part 102, which increases bending rigidity of the bridge part 102. Further, a second projection part 102B is formed extending in the direction crossing the first projection part 102A, in the plane of the bridge part 102 facing the diaphragm 10. This second projection part 102B acts as a reinforcing rib at both end parts of the bridge part 102, and rigidly supports the bridge part 102 at the outer peripheral frame part 101 by both end parts.

Further, the bridge part 102 has a third projecting part 102C crossing the first projection part 102A and the second projecting part 102B. The third projecting part 102C is formed in the plane of the static part 100 facing the diaphragm 10, and a reinforcing part 103 having polygonal planar shape is formed with a plurality of the second projection part 102B and the third projecting part 102C.

Further, the first component member 12B includes the outer peripheral frame part 101 of the static part 100 as a first outer peripheral frame part 101A, and includes a second outer peripheral frame part 101B supporting the diaphragm 10 inside the first outer peripheral frame part 101A. An opening inside the second outer peripheral frame part 101B is sealed by the edge 11 and the diaphragm 10. A projection part 101B1 projecting in the sound emission direction is formed at the second outer peripheral frame part 101B by which the diaphragm 10 is supported via the edge 11. With this projection part 101B1, rigidity to support the circumference of the diaphragm 10 is obtained.

The first component member 12B and the second component member 12C configuring the static part 100 are formed in a planar shape having a long axis and a short axis, and the bridge part 102 is formed in the short axial direction. Further, the bridge part 102 may be formed in the long axial direction or in the long and short axial directions, and thus rigidity of the static part 100 may be obtained.

Projecting parts 100m are formed at the four corners of the first component member 12B, and recessed parts 100n are formed at the four corners of the second component member 12C. The projecting parts 100m and the recessed parts 100n are fitted such that the first component member 12B and the second component member 12C are connected. The projecting part 100m may be formed at one of the first component member 12B and the second component member 12C, and the recessed part 100n may be formed at the other one of the first component member 12B and the second component member 12C. The recessed part 100n may be formed to be a hole.

The vibration direction converter part 50 includes a first link part 51A and a second link part 51B as the link body 50L, and one end part of the second link part 51B is supported by the first link part 51A and the other end is supported by the bridge part 102. The bridge part 102 supporting the second link part 51B is formed in a tabular shape, and a coupling part 104, where the other end of the second link part 51B and the bridge part 102 are connected, forms a single plane.

With the other end of the second link part 51B fitted in the bridge part 102, the vibration direction converter part 50 and the bridge part 102 are connected. A projection part 104A is formed at the coupling part 104 of the bridge part 102, and a hole 104B in which the projection part 104A is inserted, is formed at the coupling part 53C integrally formed at the end of the second link part 51B via the hinge part 52.

The projection part 104A of the coupling part 104 in the bridge part 102 acts as a positioning part positioning the vibration direction converter part 50 with respect to the static part 100. The vibration direction converter part 50 is positioned with respect to the static part 100, with the projection part 104A inserted into the hole 104B at the coupling part 53C, which is integrally formed at the end of the second link part 51B via the hinge part 52.

In the condition that the first component member 12B and the second component member 12C as a static part 100 are connected, the second coupling part 53B of the vibration direction converter part 50 is connected to the rear side of the diaphragm 10 supported by the first component member 12B, and the static coupling part 53C of the vibration direction converter part 50 is connected to the coupling part 104 formed at the central part of the bridge part 102 in the second component member 12C.

A second coupling part 53B is a part integrally connected to the end part of a first link part 51A via a hinge part 52B, and by connecting this second coupling part 53B to the diaphragm 10, the end part of the first link part 51A and the diaphragm 10 are connected together. Further, the diaphragm 10 opposing to the second coupling part 53B has a recessed part formed on the face on the sound emission side, and the diaphragm 10 has rigidity. A stationary coupling part 53C is a part integrally connected to the end part of the second link part 51B via the hinge part 52D, coupling part 53C has a hole part 104B and a protrusion part 104A of the coupling part 104 is inserted into this hole part 104B and the coupling part 104 and the end part of the second link part 51B are connected together.

The voice coil support part 40 supporting the voice coil 30 has one end of the voice coil support part 40 in the vibration direction attached to the coupling part 60, and the coupling part 60 is attached extending along the width of the voice coil support part 40. The coupling part 60 has a connecting step part 60s and a through hole 60p. The connecting step part 60s is formed such that the first coupling portion 53A of the vibration direction converter part 50 can be detachably connected to the connecting step part 60s. The through hole 60p passes through the coupling part 60 in the vibration direction of the voice coil support part 40. The through hole 60p is a venting hole which is formed to reduce air resistance applied to the coupling part 60 in response to the vibration of the voice coil support part 40.

The coupling part 60 connects the first coupling portion 53A of the vibration direction converter part 50 and the end part of the voice coil support part 40 with an interval therebetween, whereby the height of magnetic circuit 20 can be included in the height of the vibration direction converter part 50.

The voice coil support part 40 and the coupling part 60 are held at the first configuration member 12B and the second configuration member 12C by the holding parts 15. The holding parts 15 is provided with a first holding part 15A and a second holding part 15B having a curved plate member which allows one direction transformation in the vibration direction of the voice coil support part 40 but restricts transformation in the other directions. The first holding part 15A and the second holding part 15B hold the voice coil support part 40 to the first configuration member 12B and the second configuration member 12C via an attachment unit 16. The first holding part 15A holds the coupling part 60 to one side part of the attachment unit 16, the end parts inside the first holding part 15A provided at right and left sides are connected to both outside end parts of the coupling part 60, and each end part outside the first holding part 15A is connected to the attachment 16 respectively. Further, the first holding part 15A is formed with conducting metal, and electrically connected to a voice coil lead wire 31 pulled out from the end part of the voice coil 30 via a conducting layer 32 such that an audio signal is supplied to the voice coil 30 via the first holding part 15A. Further, the first holding part 15A is electrically connected to linear terminal parts 81, 81 supported by the frame 12, and electrically connected to the outside via tinsel wires 82, 82 which are electrically connected to these terminal parts 81, 81 respectively.

The central part of the second holding part 15B is connected to another side part of the attachment unit 16, and both end parts of the second holding part 15B are connected to left and right end parts of the voice coil support part 40 (base). In this example, the second holding part 15B is arranged within the width of the voice coil support part 40 (base), such that a holding body of the voice coil support part 40 (base) take up little space in the width direction of the voice coil support part 40 (base). Further, the second holding part 15B is formed with a continuous member, having a continuous shape in the central part. However, the second holding part 15B may be formed with a plurality of members and is not limited to being formed with a continuous member. A part of the second holding part 15B is arranged projecting from the static part 100 toward outside, but not limited to this arrangement and may be modified so as to fit inside the static part 100.

FIG. 37 is an exploded perspective view of attachment of the attachment unit 16 to the second holding part 15B seen from an angle. The second holding part 15B and the attachment unit 16 as unitized parts are connected to each other via adhesive resin. Tabular parts F, F at left and right end parts of the second holding part 15B are connected to connecting parts 40g, 40g at left and right end parts of end edge 40f arranged in the vibration direction of the voice coil support part 40 (base) via connecting components 40g1, 40g1 respectively, and a flat part F at the center of the second holding part 15B is connected to a connecting end part 16f1 of the attachment units 6. The end edge 40f of the voice coil support part 40 (base) in the side opposite to the side of the vibration direction converter part of the voice coil support part 40 (base) is formed in a recessed shape toward the voice coil 30, and the voice coil support part 40 (base) vibrates in response to vibration of the voice coil 30, and the voice coil support part 40 (base) is planarly formed preventing contact with the attachment unit 16. Specifically, a comparatively large gap is formed between the connecting end part 16f1 of the attachment unit 16 and the end edge 40f of the voice coil support part 40 (base), and the voice coil support part 40 (base) is planarly formed, projecting toward the second holding part 15B as getting closer to the flat parts F at left and right end parts of the second holding part 15B. Further, hole parts, in which connecting parts 40g at both end parts of the other end edge 40f of the voice coil support part 40 are inserted, are formed at the flat parts F at both end parts of the second holding part 15B.

To input an audio signal to the voice coils 30, 30 corresponding to a plurality of the driving parts 14, a pair of terminal parts 81, 81 common to a plurality of the voice coils 30, 30, extending from one voice coil 30 to another voice coil 30 of the plurality of the voice coils 30, 30, is provided at the static part 100. Further, the terminal parts 81, 81 are arranged in an opening part (not shown) formed between the first component member 12C and the second component member 12D constituting the frame 12 being the static part 100. In such a configuration, arrangement of the terminal part can be space saved compared to the arrangement where terminal parts are provided on both end parts of the voice coil 30 respectively, thus the speaker device can be made compact or thin. Further, the terminal parts 81, 81 can be stably fixed to the static part 100, preventing bad connection to the voice coils 30, 30. Further, the terminal parts 81, 81 are formed in a shape including a long axis extending from one voice coil 30 to another voice coil 30 and a short axis intersecting the long axis. With this longitudinal shape, efficiency of installation space of the terminal parts can be increased.

A connecting part 81a to wires 82, 82 (second wire) connected to the outside is foamed in the terminal parts 81, 81, and the terminal parts 81, 81 are electrically connected to the wires at the connecting parts 81a. The wires 82 (second wire) are fixed to the side face of the static part 100 and are connected to the terminal parts 81, 81. The outer peripheral frame part 101 of the static part 100 includes a side face to which the wire 82 is attached, and guiding parts 106, 106 guiding the wire 82 are formed in the side face of the static part 100.

The conducting layer 32, connected to the voice coil lead wire 31 pulled out of the end part of the voice coil 30, is formed on the voice coil support part 40 (base) supporting the voice coil 30. The conducting layer 32 is pattern formed on the voice coil support part 40 (base), surrounding the conducting member of the voice coil 30, and the conducting layer 32 electrically connects the conducting member of the voice coil 30 to the holding part 15.

A wire, electrically connecting the voice coil 30 to the terminal part 81 is formed in the holding part 15, and the end parts of the terminal parts 81, 81 are electrically connected to the wire, the wire of the holding part 15 is connected to the voice coil lead wire, the wire 82 is connected to the terminal parts 81, 81, and thereby an audio signal is inputted from the outside to the voice coil 30.

FIG. 38 is a partially enlarged view seeing FIG. 35 from a different direction, and FIG. 38(a) particularly shows that one connecting face F2 of the first holding part 15A is connected to a connecting terminal part 32a of the conducting layer 32. FIG. 38(b) particularly shows that another connecting face F1 of the first holding part 15A is connected to the terminal part 81. The connecting face F1 at one end side of the first holding part 15A is connected to the terminal part 81, and the connecting face F2 at another end side of the first holding part 15A is connected to the voice coil lead wire 31 via the connecting terminal part 32a of the conducting layer 32. The terminal part 81 electrically connects one end parts of the pair of the first holding part 15A to the wire 82 (outside), and an audio signal inputted from the wire 82 is supplied to the voice coil lead wire 31 via the terminal part 81 and the first holding part 15A. The terminal part 81 is formed with a rod shaped conducting member, having a positioning hole, and is positioned at the specific point of the static part 100 with a positioning protrusion part 111 provided at the static part 100 being inserted into the positioning hole. Insulating is applied to a part of the terminal part 81, and the surface of the conducting member in the region connecting to the connecting face F1 of the first holding part 15A is exposed, enabling an electrical connection to the first holding part 15A. Further, the terminal part 81 may be formed with a member including an insulating property such as a resin member, etc. (insulating member), and a conducting member may be provided on the insulating member, thereby electrically connecting to the connecting face F1 of the holding part 15.

The attachment unit 16 includes a first connecting part 16a to which the end part of the first holding part 15A is connected, being provided at left and right sides of the coupling part 60, and a second connecting part 16b to which the second holding part 15B is connected, being provided at the back of the voice coil support part 40, and a unitized supporting part 16c integrally supporting the first connecting part 16a and the second connecting part 16b. Also, the attachment unit 16 includes at the four corners connecting hole parts 16d opposing projecting parts 100m provided at the first component member 12C of the static part 100. The projecting part 100m is inserted into a recessed part 100n of the connecting hole part 16d and the second component member 12D, thereby the voice coil support part 40 (base), the coupling part 60, the holding part 15 and the attachment unit 16 are unitized and fixed between the first component member 12B and the second component member 12C.

Further when such a speaker device 1T is assembled, the first coupling portions 53A (R), 53A (L) of the vibration direction converter part 50 as shown in FIGS. 20 and 21 are attached to the connecting step part 60s of the coupling part 60 respectively, whereby the voice coil support part 40, the coupling part 60, the holding parts 15 (first holding part 15A and second holding part 15B) and attachment unit 16 which have already been unitized and the vibration direction converter part 50 are integrally formed, and the upper side yoke part 22B and lower side yoke part 22A of the magnetic circuit 20 are arranged on the upper side and lower side of these parts (voice coil support part 40 and so forth) respectively, and the upper side yoke part 22B and lower side yoke part 22A are sandwiched between the first configuration member 12B and the second configuration member 12C of the static part 100. As such, the stationary coupling part 53C of the vibration direction converter part 50 fits into and is immobilizedly supported by a support base 12D which is formed at the bottom part 12A of the second configuration member 12C, and other components such as attachment unit 16 are also positioned at predetermined positions with respect to the first configuration member 12B and the second configuration member 12C. Further, protruding parts 100m provided at the first configuration member 12B of the static part 100 are inserted into connecting hole parts 16d provided at the four corners of the attachment unit 16, whereby the attachment unit 16 is fixed at a predetermined position with respect to the static part 100.

As indicated in the example, the upper side yoke part 22B of the magnetic circuit 20 is incorporated with respect to the inner face of the first configuration member 12B, and the attachment unit 16, the vibration direction converter part 50 and so forth are subsequently incorporated and positioned respectively, and the second configuration member 12C is superimposed to sandwich each component while the lower side yoke part 22A of the magnetic circuit 20 is incorporated. Finally, the second coupling part 53B of the vibration direction converter part 50 and the diaphragm 10 are connected to each other with adhesive as a connecting member, while the outer periphery part of the diaphragm 10 is attached to a second outer peripheral frame part 101B of the first configuration member 12B via the edge 11. Further, in the proximity of near the outer periphery part of the edge 11, a groove part is circumferentially formed at the bottom part of the second outer peripheral frame part 101B, and the groove part is formed as a connecting member receiving part for receiving adhesive which runs off when connecting the edge 11 and the first configuration member 12B. Further, a projection part projecting from the outer periphery part of the edge 11 toward the frame 12B is formed and the projection part enters into the groove part, whereby the connecting force between the edge 11 and the first configuration member 12B can be improved.

Further, the assembling process may be changed as described below: First, a tinsel wire 82 is connected to connecting terminals 81, 81 and the magnet 21 is connected to the yoke part 22. Next, the connecting terminals 81, 81 to which the tinsel wire 82 is connected is attached to an outer peripheral frame part 101A of the first configuration member 12B. Next, a pair of the attachment unit 16 to which the aforementioned voice coil 30 is attached to the first configuration member 12B. At this point, the connecting terminals 81, 81 and the holding part 15A which is attached to the attachment unit 16 are electrically connected by soldering and so forth. Next, the vibration direction converter part 50 is attached to the coupling part 104 and the vibration direction converter part 50 and the voice coil 30 are connected to each other. Next, a second configuration member 12C is arranged on the first configuration member 12B and a magnetic pole member (yoke part) 22 to which the magnet 21 is connected is attached to the outer peripheral frame part 101A of the second configuration member 12C. Next, the diaphragm 10 and the edge 11 are attached to the second outer peripheral frame part 101B of the first configuration member 12B. Next, the magnetic pole member (yoke part) 22 to which the magnet 21 is connected is attached to the first outer peripheral frame part 101A of the first configuration member 12B. Finally, the tinsel wire 82 is attached to a guiding part 106 which is provided on the first outer peripheral frame part 101A of the first configuration member 12B.

The frame 12 as the static part 100 is provided with the first configuration member (first frame) 12B and the second configuration member 12C (second frame), and the first configuration member 12B is arranged on the sound emission side of the speaker device 1T and the second configuration member 12C is arranged on the side opposite the sound emission side (rear side). The driving part 14 of the speaker device 1 is supported while being sandwiched by the first configuration member 12B and the second configuration member 12C.

The outer peripheral frame part 101 which is formed annularly and provided on the first configuration member 12B supports one side (22B) of the magnetic pole member (yoke part) 22 of the magnetic circuit 20. While, the second configuration member 12C is provided with the outer peripheral frame part 101 and the bridge part 102, and supports the other side (22A) of the magnetic pole member (yoke part) 22 of the magnetic circuit 20.

The first configuration member 12B and the second configuration member 12C are provided with recessed shaped receiving parts 105 for receiving a part of the yoke part 22. A projection part 22p fits into the receiving parts 105 and the yoke part 22 is positioned in order to form an appropriate magnetic gap. Further, an opening part 101S is formed between the outer peripheral frame part 101 and the bridge part 102. In the outer peripheral frame part 101, a fourth protrusion part (not shown) is formed along the outer periphery edge of the opening part 101S. The fourth protrusion part increases torsional rigidity of the outer peripheral frame part 101.

Further, in the first configuration member 12B, an excessive-vibration restraining part 108 (see FIG. 38) for restraining the excessive-vibration of the voice coil 30 is formed. The projects in a moving region of the voice coil 30, particularly in a notch part which is formed at the end edge of the voice coil 30 in the vibration direction of the voice coil 30, and the excessive-vibration of the voice coil 30 is restrained by the voice coil support part 40 having contact with the excessive-vibration restraining part 108.

The magnetic circuit 20 is attached to the first configuration member 12B and the second configuration member 12C with the magnetic pole member 22 connected to the magnet. The magnetic pole member 22 is provided with a plurality of projection parts 22p and the projection part 22p are supported by the receiving parts 105. The yoke part 22, which is a plate shaped magnetic body, is getting smaller in width from the vibration direction converter part 50 to the static part 100, whereby the holding part 15 is prevented from having contact with the yoke part 22.

In the magnetic circuit 20, the yoke parts 22A, 22B are attached to the first configuration member 12B and the second configuration member 12C, and the first configuration member 12B and the second configuration member 12C are connected such that an interval as the magnetic gap 20G is provided between the yoke parts 22A and 22B or between the magnets 21.

According to this embodiment, the height of the magnetic circuit 20 substantially coincides with the total height of the entire device, and the voice coil support part 40 is configured to vibrate near the center of the magnetic circuit 20, wherein the end part of the voice coil support part 40 and the end part of the vibration direction converter part 50 are connected to each other at different heights via the coupling part 60. As such, sufficient length of each link part of the vibration direction converter part 50 can be secured within the height of the device, as well as a part of the height of the magnetic circuit 20 can be included within the height of the vibration direction converter part 50. Further, since an interval is formed between the first configuration member 12B and the upper side yoke 22B arranged in the proximity of near the first configuration member 12B, the vibration of the diaphragm 10 is prevented from being transmitted to the magnetic circuit 20 via the upper yoke part 22B such that the contact between the magnetic circuit 20 and the voice coil 30 is induced.

As such, a speaker device according to an embodiment of the present invention can be made thin, while enabling to emit loud sound. Further, a thin speaker device which can emit loud reproduced sound with comparatively simple structure can be obtained by vibrating the diaphragm in the different direction from the vibration direction of the voice coil. At this point, if the vibration direction of the voice coil is converted to a different direction by using a mechanical link body, durability for withstanding high-speed vibration as well as flexibility for suppressing abnormal noise in high-speed vibration may be required for the hinge parts of the link body. According to the configuration of the aforementioned speaker device, the hinge parts of the link body can have the durability and flexibility.

Further, in order to direction-convert the vibration of the voice coil and transmit the vibration to the diaphragm, the vibration of the voice coil is required to be reproduced efficiently and accurately even after conversion of direction, and thus the link body may be required to suppress mechanical distortion and the link body itself may be lightweight. Further, easiness of working when incorporating such a link body into a speaker device and easiness of manufacturing when manufacturing the link body itself may be required. According to the aforementioned configuration of a speaker device, reduction in weight and easiness of manufacturing can be achieved.

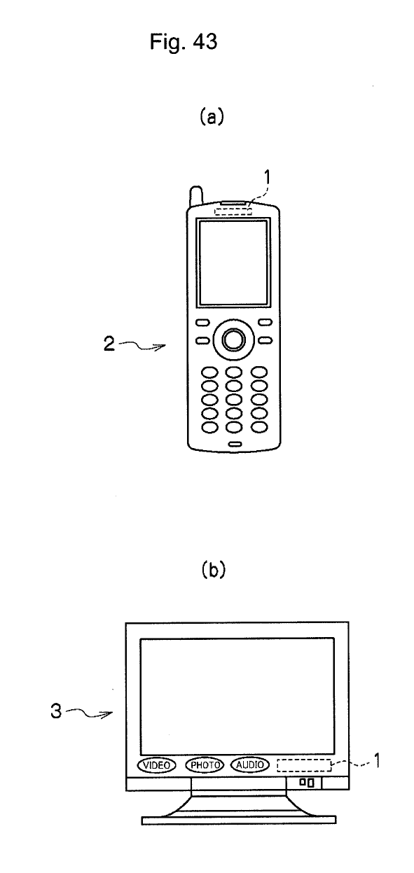

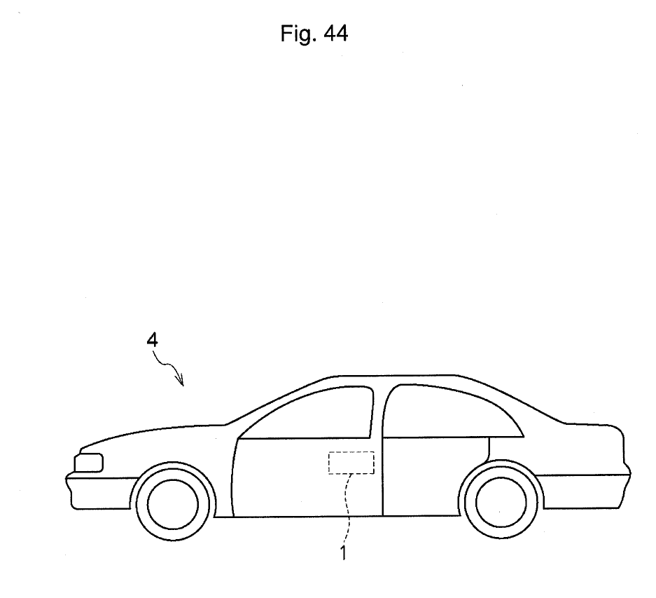

Such a speaker device can be effectively employed for various types of electronic devices and in-car devices. FIG. 43 is a view illustrating electronic devices equipped with a speaker device according to an embodiment of the present invention. In an electronic device 2 such as a portable telephone or a personal digital assistance as shown in FIG. 43(a), or an electronic device 3 such as a flat panel display as shown in FIG. 43(b), even when the speaker device 1 is housed in a housing as an attaching counterpart which is provided for the electronic device 3, or the speaker device 1 is attached to the side face of the housing of an electronic device as an attaching counterpart, the thickness space required for attachment of the speaker device 1 can be reduced, whereby the entire electronic device can be made thin. Further, even in an electronic device which has been made thin, a sufficient audio output can be obtained. FIG. 44 is a view illustrating an automobile equipped with a speaker according to an embodiment of the present invention. In an automobile 4 shown in FIG. 44, space in a car can be extended in accordance with reduction in thickness of the speaker device 1. In particular, even if the speaker device 1 according to an embodiment of the present invention is installed on a door panel or a ceiling as an attaching counterpart, the protrusion of the door panel or ceiling can be comparatively reduced, thereby allowing the operation space for a driver or space in a room of a car to extend. Also, with sufficiently large audio output, one can comfortably enjoy listening to music or radio broadcasts in a car even during noisy high-speed traveling and so forth.

Further, when the speaker device 1 is installed in buildings including a residential house (building) or a hotel, an inn, training facilities and so force (building), which can accommodate many guests for conferences, meetings, lectures, parties, etc., when the speaker device 1 is installed on the wall or ceiling as an attaching counterpart, the installation space required for the speaker device 1 may be reduced in the thickness direction, whereby unused space in a room can be eliminated and the space can be effectively used. Further, a living room provided with audiovisual equipment has burgeoned in recent years with prevalence of a projector and a big-screen TV, while there is still a case where a living room and so forth is used as a theater room instead of having a room provided with audiovisual equipment. Also in such a case, a living room, etc. can be easily converted to a theater room by using the speaker device 1 while making effective use of the space in the living room. Particularly, the speaker device 1 may be arranged, for example, on the ceiling, the wall and so forth in a living room.

Although the embodiments according to the present invention are described with reference to the drawings, specific configurations are not limited to these embodiments, and alterations and modifications not departing from the subject matter of the present invention are included in the scope of the present invention. Further, the technologies of each embodiment described above can be used by each other, unless specific contradictions or problems are involved in their objects, the configurations, and so forth. In addition, PCT/JP2008/051197 filed on Jan. 28, 2008, PCT/JP2008/068580, filed on Oct. 14, 2008, PCT/JP2008/069480 filed on Oct. 27, 2008, PCT/JP2008/069269 filed on Oct. 23, 2008, PCT/JP2009/053752 filed on Feb. 27, 2009 PCT/JP2009/053592 filed on Feb. 26, 2009, PCT/JP2009/050764 filed on Jan. 20, 2009, PCT/JP2009/055533 filed on Mar. 19, 2009, PCT/JP2009/055496 filed on Mar. 19, 2009, PCT/JP2009/055497 filed on Mar. 19, 2009, PCT/JP2009/055498 filed on Mar. 19, 2009, PCT/JP2009/055534 filed on Mar. 19, 2009, PCT/JP2009/055523 filed on Mar. 19, 2009, PCT/JP2009/055524 filed on Mar. 19, 2009, PCT/JP2009/055525 filed on Mar. 19, 2009, PCT/JP2009/055526 filed on Mar. 19, 2009, PCT/JP2009/055527 filed on Mar. 19, 2009, and PCT/JP2009/055528 filed on Mar. 19, 2009, the entirety of which is incorporated by reference into the present application.

1. A speaker device, comprising:
a diaphragm;
a static part for vibratably supporting said diaphragm in the vibration direction; and
a driving part provided at said static part and applying vibration to said diaphragm with an audio signal,
wherein said driving part comprises:
a magnetic circuit forming a magnetic gap;
a voice coil vibrating in a different direction from said vibration direction of said diaphragm in response to an inputted audio signal; and
a rigid vibration direction converter part direction-converting said vibration of said voice coil and transmitting said vibration to said diaphragm; and
said vibration direction converter part is connected to an attaching counterpart including said diaphragm and said voice coil and includes a hinge part located in the proximity of said attaching counterpart, and
a contact avoiding part avoiding contact with said hinge part is formed on the face side of said attaching counterpart in the proximity of said hinge part.

2. The speaker device according to claim 1, wherein said contact avoiding part is formed as a connecting member restraining part preventing the connecting member interposed between said vibration direction converter part and said attaching counterpart from being involved in said hinge part.

3. The speaker device according to claim 1, wherein said vibration direction converter part includes a rigid link part and said hinge part, and said link part is angle-variably and obliquely disposed between said voice coil and said diaphragm, and said hinge parts are formed at both end parts of said link part.

4. The speaker device according to claim 1, wherein said vibration direction converter part includes a link body angle-converting a link part formed between said voice coil supporting part and said diaphragm.

5. The speaker device according to claim 5, wherein said vibration direction converter part including as a first link part said link part obliquely disposed with respect to said vibration direction of voice coil and a vibration direction of said diaphragm,
a second link part constituting said link body and being obliquely disposed with respect to said first link part, wherein
said second link part has one end part connected to the middle part of said first link part via said hinge part;
the other end part connected to said static part via said hinge part.

6. The speaker device according to claim 1, comprising a coupling portion, wherein said coupling portion arranged between an end part of said vibration direction converter part on said voice coil side and an end part of said voice coil on said vibration direction converter part side, connects with both said end parts, such that positions of both said end parts are different in said vibration direction.

7. The speaker device according to claim 1, wherein said contact avoiding part is formed along said hinge part.

8. The speaker device according to claim 7, wherein said hinge part is formed into linear shape.

9. The speaker device according to claim 8, wherein said contact avoiding part includes a shape extending beyond the both end parts of said hinge part, and is formed in a recessed shape with respect to said hinge part.

10. The speaker device according to claim 9, wherein a total length of said contact avoiding part formed in said attaching counterpart is substantially the same or larger than the width of said vibration direction converter part along the contact avoiding part.

11. The speaker device according to claim 10, wherein said contact avoiding part is formed at an end part of said attaching counterpart provided in the proximity of said hinge part.

12. The speaker device according to claim 11, wherein a notch part as said contact avoiding part is formed at said end part of said attaching counterpart.

13. The speaker device according to claim 12, wherein a groove part filled with adhesive is formed at either said attaching counterpart or said vibration direction converter part.

14. The speaker device according to claim 1, wherein said vibration direction converter part is formed by combining a plurality of sheet shaped components, and
said hinge part and said contact avoiding part corresponding to said hinge part are provided in the proximity of coupling part of said plurality of sheet shaped components, and
said contact avoiding part is formed on the face side of one of said sheet shaped components of said plurality of sheet shaped components in the proximity of said hinge part arranged in the other of said sheet shaped components.

15. The speaker device according to claim 14, comprising two of said driving part, and
said two coupling parts of said sheet shaped components are formed by connecting two end edges of said sheet shaped components in the vibration direction of said voice coil, and
said coupling part of said sheet shaped components is connected to said voice coil of said driving part.

16. The speaker device according to claim 15, wherein said one sheet shaped component includes a plurality of first link parts oppositely arranged and obliquely disposed with respect to the vibration directions of said voice coil and said diaphragm,
a plurality of second link parts oppositely arranged and crossing the first link parts,
both end parts of said first link part are connected to said voice coil and said diaphragm via said hinge parts, and
one end part of said second link part is connected to the middle part of said first link part via said hinge part, and the other end part of said second link part is connected to said static part via said hinge part.

17. The speaker device according to claim 16, comprising a third link part between said first link parts or between said second link parts, wherein said third link part extends in the vibration direction of said voice coil, and is connected to said diaphragm or said static part.

18. The speaker device according to claim 17, wherein said the one sheet shaped component includes a plurality of fourth link parts arranged substantially in parallel with said first link part, and oppositely arranged at a prescribed interval;
a fifth link part arranged substantially in parallel with said third link part, and oppositely arrange at a prescribed interval, wherein
said fifth link part is connected to said third link part connected to said diaphragm.

19. The speaker device according to claim 18, comprising a coupling portion arranged between said coupling part of said sheet shaped component and said end part of said voice coil on the side of said vibration direction converter part, wherein
said coupling portion connects both said end parts such positions of both said end parts are different in said vibration direction, and
said coupling part for said sheet shaped component is connected to said coupling portion via said hinge part.

20. The speaker device according to claim 19, wherein said contact avoiding part is arranged on the face side of said coupling portion opposing to said sheet shaped component.

21. The speaker device according to claim 18, wherein said contact avoiding part is arranged on the face side of said third link part arranged on the side of said diaphragm opposing fifth link part in the proximity of said hinge part arranged between said fourth link part and said fifth link part.

22. The speaker device according to claim 18, wherein a contact avoiding part is arranged on the face side of said diaphragm opposing said first link part in the proximity of said hinge part arranged between said first link part and said third link part on the side of said diaphragm.

23. The speaker device according to claim 18, wherein in the proximity of said hinge part arranged between said third link part and said first link part,
said contact avoiding part is arranged on the face side of said static part opposing said third link part.

24. The speaker device according to claim 1, wherein said hinge part between said vibration direction converter part and said diaphragm is formed by one end part of said vibration direction converter part being inserted into said diaphragm, and said contact avoiding part is arranged in the proximity of said hinge part.

25. The speaker device according to claim 24, wherein said contact avoiding part is arranged on the face side of said diaphragm or on the face side of one end part of said vibration direction converter part.

26. The speaker device according to claim 1, wherein a continuous member constituting said hinge part covers a surface of said link part on the side of the connecting member or both faces of said link part on the side of the connecting member.

27. The speaker device according to claim 26, wherein said link part is configured with at least a single resin film, and said continuous member is configured with at least two resin films, and
said two resin films constituting said continuous member sandwiches a part of said link part, and
a protrusion part or a groove part applying rigidity to said link part is formed on the resin film constituting said link part.

28. The vibration direction converter part according to claim 27, wherein a metal member constituting said link part is arranged in the resin film.

29. The speaker device according to claim 1, wherein the resin members constituting said continuous member and said link part are different from each other, and said continuous member and said link part are formed by concurrent molding.

30. The speaker device according to claim 1, wherein at least two regions with different bending rigidity are formed in said voice coil supporting part or said link part.

31. The speaker device according to claim 30, wherein said two regions with different bending rigidity are formed by attaching a reinforcing member to said link part or said voice coil supporting part.

32. The speaker device according to claim 30, wherein said two regions with different bending rigidity are formed by providing a notch part to said link part or said voice coil supporting part.

33. The speaker device according to claim 1, wherein said voice coil includes a plane shaped and annularly wound conducting member and a rigid base supporting said conducting member,
and a conducting layer is pattern formed on the surface of said base outside said conducting member.

34. The speaker device according to claim 33, wherein a pair of said conducting layers is arranged so as to surround said conducting member, and functions as a junction wire for inputting an audio signal into said conducting member.

35. The speaker device according to claim 1, comprising a first holding part vibratably holding said voice coil in the vibration direction of the said voice coil to said static part directly or via other member.

36. The speaker device according to claim 35, comprising a second holding part vibratably holding said voice coil in the vibration direction of said voice coil to said static part directly or via other member.

37. The speaker device according to claim 36, comprising a coupling portion arranged between said end part of said vibration direction converter part on the side of said voice coil and said end part of said voice coil on the side of said vibration direction converter part, wherein said coupling portion connects both said end parts with the positions of both said end parts being different in said vibration direction;
said first holding parts are arranged at right and left sides of said coupling portion between said coupling portion and said static part;
said second holding part is arranged at right and left sides of said voice coil on the side of said static part with respect to said first holding part; and
said first holding part and said second holding part hold said voice coil to said static part substantially symmetrically directly or via other member.

38. The speaker device according to claim 37, wherein a central part of said second holding part is held by said static part directly or via other member, and both ends of said second holding part are connected to right and left end parts of said voice coil.

39. The speaker device according to claim 37, wherein said first holding part and said second holding part hold said coupling portion and said voice coil to said static part via an attachment unit.

40. An electronic device comprising said speaker device according to claim 1.

41. A vehicle comprising said speaker device according to claim 1.

42. A building comprising said speaker device according to claim 1.

43. A speaker device, comprising:
a diaphragm;
a static part for vibratably supporting said diaphragm in the vibration direction; and
a driving part arranged at said static part and applying vibration to said diaphragm by an audio signal,
wherein said driving part comprises:
a magnetic circuit forming a magnetic gap;
a voice coil vibrating in a different direction from the vibration direction of said diaphragm in response to an inputted audio signal; and
a rigid vibration direction converter part direction-converting the vibration of said voice coil and transmitting said vibration to said diaphragm; and
said vibration direction converter part is connected to an attaching counterpart including said diaphragm and said voice coil and includes a hinge part located in the proximity of said attaching counterpart, and
a connecting member restraining part is formed on the face side of said attaching counterpart in the proximity of said hinge part and prevents a connecting member interposed between said vibration direction converter part and said attaching counterpart from being involved in said hinge part.
